(19) United States
(12) Patent Application Publication
(10) Pub. No.: US 2025/0324129 A1
(43) Pub. Date: Oct. 16, 2025

(54) DISPLAY APPARATUS AND PROCESSING METHOD FOR DISPLAY APPARATUS

(71) Applicant: HISENSE VISUAL TECHNOLOGY CO., LTD., Qingdao (CN)

(72) Inventors: Guili JIA, Qingdao (CN); Xiaoming SHAO, Qingdao (CN); Tao LI, Qingdao (CN); Jie FAN, Qingdao (CN); Lifei YAN, Qingdao (CN)

(21) Appl. No.: 19/251,446

(22) Filed: Jun. 26, 2025

Related U.S. Application Data
(63) Continuation of application No. PCT/CN2023/134846, filed on Nov. 28, 2023.

(30) Foreign Application Priority Data
Dec. 30, 2022 (CN) 202211721340.4
Dec. 30, 2022 (CN) 202211737411.X
Feb. 3, 2023 (CN) 202310093843.X
Apr. 14, 2023 (CN) 202310402904.6

(51) Int. Cl. H04N 21/431; H04N 21/485

(52) U.S. Cl. CPC H04N 21/4316; H04N 21/4858

(57) ABSTRACT

A display apparatus includes: a display; a user input interface; a communicating device; a memory; and at least one processor configured to execute computer instructions to cause the display apparatus to perform: based on detecting that a target video is being played by a video playing application on the display apparatus, displaying a user prompt interface, wherein the user prompt interface is used for prompting a user whether to enter a split screen working mode; based on that a command for entering the split screen working mode input from a user on the user prompt interface is received, splitting a display interface of the display apparatus into a first split screen and a second split screen, and starting a search application; displaying an interface of the video playing application on the first split screen, and displaying an interface of the search application in full screen on the second split screen.

### CROSS-REFERENCE TO RELATED APPLICATIONS

This application is a continuation application of International Application No. PCT/CN2023/134846, filed on Nov. 28, 2023, which claims priorities to Chinese Patent Application No. 202211721340.4, filed on Dec. 30, 2022, Chinese Patent Application No. 202211737411.X, filed on Dec. 30, 2022, Chinese Patent Application No. 202310093843.X, filed on Feb. 3, 2023, and Chinese Patent Application No. 202310402904.6, filed on Apr. 14, 2023, the contents of all of which are hereby incorporated by reference in their entireties.

### TECHNICAL FIELD

The present disclosure relates to the technical field of display, and particularly to a display apparatus and a processing method for a display apparatus.

### BACKGROUND

At present, with the rapid development of computer technology, a user can browse media resource information related to a currently played video by using a search application on a display apparatus while watching the video by using the display apparatus such as a smart television.

In the related art, when a user needs to search and browse media resource information related to a currently played video according to a search application during watching the video, the user needs to manually set, that is, the user needs to enter a setting mode to perform split screen setting on a display interface of a display apparatus, so that through different split screens on the display interface of the same display apparatus, the user can not only watch the video, but also search through the search application to obtain the media resource information related to the currently played video.

However, with the related art, the user needs to manually set the split screen, and the operation is cumbersome, reducing user experience.

### SUMMARY

A display apparatus according to embodiments of the present disclosure, including: a display, configured to display an image and/or a user interface; a user input interface, configured to receive a command from a user; a communicating device, configured to communicate with an external device according to a predetermined protocol; a memory, configured to store computer instructions and data associated with the display apparatus; and at least one processor, in connection with the display, the user input interface, the communicating device and the memory, and configured to execute computer instructions to cause the display apparatus to perform: based on detecting that a target video is being played by a video playing application on the display apparatus, displaying a user prompt interface, where the user prompt interface is used for prompting a user whether to enter a split screen working mode; based on that a command for entering the split screen working mode input from a user on the user prompt interface is received, splitting a display interface of the display apparatus into a first split screen and a second split screen, and starting a search application; and displaying an interface of the video playing application on the first split screen, and displaying an interface of the search application in full screen on the second split screen.

A processing method for a display apparatus according to embodiments of the present disclosure, including: based on detecting that a target video is being played by a video playing application on the display apparatus, displaying a user prompt interface, where the user prompt interface is used for prompting a user whether to enter a split screen working mode; based on that a command for entering the split screen working mode input from a user on the user prompt interface is received, splitting a display interface of the display apparatus into a first split screen and a second split screen, and starting a search application; and displaying an interface of the video playing application on the first split screen, and displaying an interface of the search application in full screen on the second split screen.

A computer readable non-transitory storage medium according to embodiments of the present disclosure stores a computer program thereon, where the computer program, when executed by a processor, causes a computer device to perform steps of the processing method for the display apparatus.

### BRIEF DESCRIPTION OF FIGURES

FIG. 1A is a schematic diagram of an application scenario among a display apparatus, a control device, and a terminal device according to some embodiments of the present disclosure;

FIG. 1B is a schematic diagram of a scenario of split screen during a video playing process in related art;

FIG. 2 is a block diagram of a hardware configuration of a control device 100 according to some embodiments of the present disclosure;

FIG. 3A is a block diagram of a hardware configuration of a display apparatus 200 according to some embodiments of the present disclosure;

FIG. 3B is a schematic diagram of a software configuration in a display apparatus 200 according to some embodiments of the present disclosure;

FIG. 3C is a schematic diagram of displaying an icon control interface of an application in a display apparatus 200 according to some embodiments of the present disclosure;

FIG. 4A is a block diagram of a system for split screen control according to some embodiments of the present disclosure;

FIG. 4B is an architecture diagram of split screen control according to some embodiments of the present disclosure;

FIG. 5A is a first flowchart of a processing method for a display apparatus according to some embodiments of the present disclosure;

FIG. 5B is a schematic diagram of a scenario of displaying a user prompt interface according to some embodiments of the present disclosure;

FIG. 5C is a schematic diagram of a scenario of displaying applications on a first split screen and a second split screen according to some embodiments of the present disclosure;

FIG. 6A is a second flowchart of a processing method for a display apparatus according to some embodiments of the present disclosure;

FIG. 6B is a schematic diagram of a scenario of a size of a preset display interface according to some embodiments of the present disclosure;

FIG. 7A is a third flowchart of a processing method for a display apparatus according to some embodiments of the present disclosure;

FIG. 7B is a schematic diagram of a scenario of quickly searching media resource information of a target video according to some embodiments of the present disclosure;

FIG. 8 is a first flowchart of a second processing method for a display apparatus according to some embodiments of the present disclosure;

FIG. 9 is a schematic diagram of a user interface of a display in a case according to some embodiments of the present disclosure;

FIG. 10 is a schematic diagram of a user interface displayed by a display in another case according to some embodiments of the present disclosure;

FIG. 11 is a schematic diagram of a user interface displayed by a display in another case according to some embodiments of the present disclosure;

FIG. 12 is a schematic diagram of a user interface displayed by a display in another case according to some embodiments of the present disclosure;

FIG. 13 is a second flowchart of a second processing method for a display apparatus according to some embodiments of the present disclosure;

FIG. 14 is a first flowchart of a third processing method for a display apparatus according to some embodiments;

FIG. 15 is a first schematic diagram of an interface of a display apparatus according to some embodiments;

FIG. 16 is a second schematic diagram of an interface of a display apparatus according to some embodiments;

FIG. 17 is a third schematic diagram of an interface of a display apparatus according to some embodiments;

FIG. 18 is a fourth schematic diagram of an interface of a display apparatus according to some embodiments;

FIG. 19 is a second flowchart of a third processing method for a display apparatus according to some embodiments;

FIG. 20 is a schematic diagram of a preset loading interface according to some embodiments;

FIG. 21 is a fifth schematic diagram of an interface of a display apparatus according to some embodiments;

FIG. 22 is a third flowchart of a third processing method for a display apparatus according to some embodiments;

FIG. 23 is a third flowchart of a third processing method for a display apparatus according to some embodiments;

FIG. 24 is a flowchart of a fourth processing method for a display apparatus according to some embodiments of the present disclosure;

FIG. 25 is a flowchart of a display apparatus displaying a first application and a second application in a split screen according to some embodiments of the present disclosure;

FIG. 26 is a flowchart of a display apparatus displaying a first application and a second application in a split screen according to some embodiments of the present disclosure;

FIG. 27 is a flowchart of Android booting according to some embodiments of the present disclosure;

FIG. 28 is a schematic diagram of a split screen operation flow provided through a System UI according to some embodiments of the present disclosure;

FIG. 29 is a flowchart of a display apparatus displaying a focus frame according to some embodiments of the present disclosure;

FIG. 30 is a schematic diagram of a system architecture of a display apparatus according to some embodiments of the present disclosure;

FIG. 31 is a flowchart of a first example of a television displaying a first application and a second application in a split screen according to some embodiments of the present disclosure;

FIG. 32 is a flowchart of a second example of a television displaying a first application and a second application in a split screen according to some embodiments of the present disclosure;

FIG. 33 is a flowchart of a third example of a television displaying a first application and a second application in a split screen according to some embodiments of the present disclosure;

FIG. 34 is a flowchart of a fourth example of a television displaying a first application and a second application in a split screen according to some embodiments of the present disclosure;

FIG. 35 is a flowchart of a display apparatus responding to a mouse operation according to some embodiments of the present disclosure;

FIG. 36 is a flowchart of a display apparatus zooming a focus window with a zooming button according to some embodiments of the present disclosure;

FIG. 37 is a flowchart of a display apparatus zooming a focus window with a zooming button according to some embodiments of the present disclosure;

FIG. 38 is a flowchart of a display apparatus zooming a focus window through a divider according to some embodiments of the present disclosure;

FIG. 39 is a flowchart of a display apparatus zooming a focus window through a divider according to some embodiments of the present disclosure;

FIG. 40 is a flowchart of a display apparatus timing detecting an application stack according to some embodiments of the present disclosure;

FIG. 41 is a flowchart of a display apparatus switching a focus window according to some embodiments of the present disclosure;

FIG. 42 is a flowchart of a display apparatus switching a focus window according to some embodiments of the present disclosure;

FIG. 43 is a flowchart of a display apparatus displaying a message prompt box according to some embodiments of the present disclosure;

FIG. 44 is a flowchart of a display apparatus displaying a message prompt box according to some embodiments of the present disclosure.

### DETAILED DESCRIPTION

In order to make the above objects, features, and advantages of the present disclosure be more clearly understood, schemes of the present disclosure will be further described below. It should be noted that embodiments of the present disclosure and features in embodiments can be combined with each other without conflict.

In the following description, numerous specific details are set forth in order to provide a thorough understanding of the present disclosure, but it is to be understood that the present disclosure can be implemented otherwise than as described herein. Apparently, embodiments described are some rather than all of embodiments of the present disclosure.

Terms “first” and “second” and the like in the present disclosure are used to distinguish between different objects and are not used to describe a particular order of objects. For example, the first processing result and the second processing result are used to distinguish different processing results, and are not used to describe a specific order of the processing results.

The display apparatus according to embodiments of the present disclosure can have various implementation forms, for example, a television, a smart television, a laser projection apparatus, a monitor, an electronic bulletin board, an electronic table, and the like. Embodiments of the present disclosure do not limit the specific type of the display apparatus.

For a case that a display apparatus detects that a display screen is static for a longer period of time, a system can start a display screen protection program to protect the display screen, to prevent the display screen from being static for a long time, which causes screen burning and reduces a user's subsequent use experience.

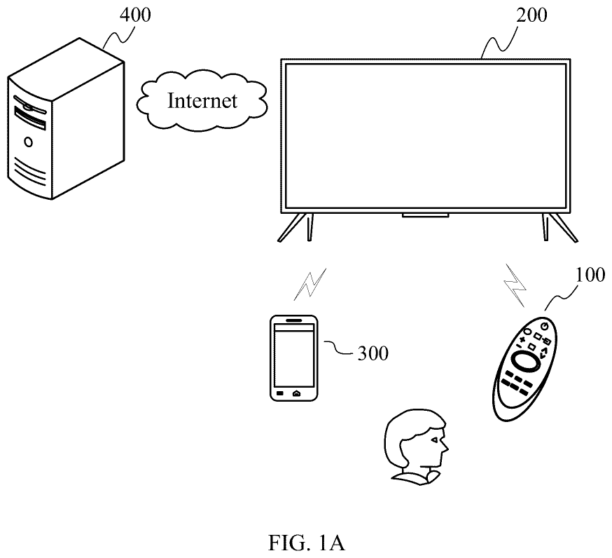

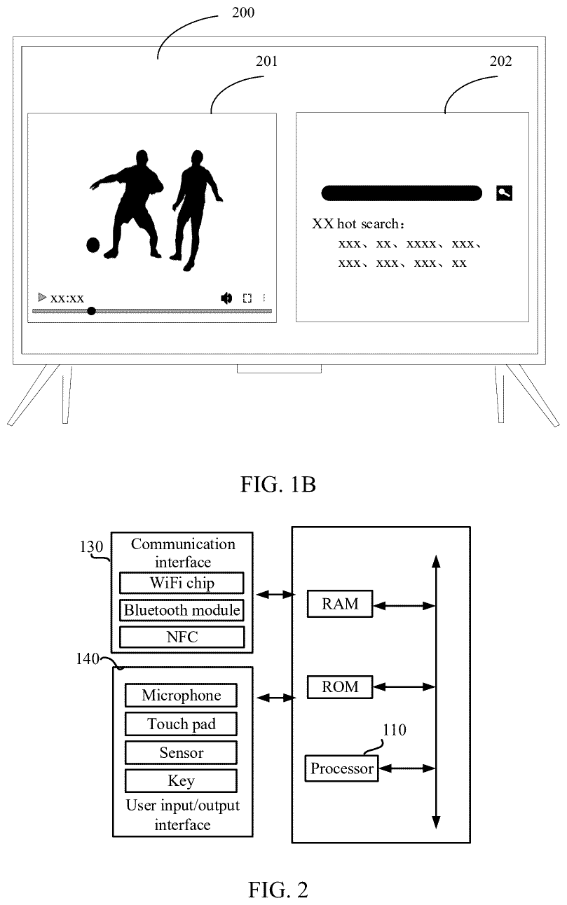

With reference to FIGS. 1A to 1B, FIG. 1A is a schematic diagram of an application scenario among a display apparatus, a control device, and a terminal device according to some embodiments of the present disclosure. FIG. 1B is a schematic diagram of a scenario of split screen during a video playing process in related art. When a user needs to further obtain media resource information of a currently played video during watching the video, the user enters a setting mode to perform split screen setting on a display interface of a display apparatus 200, so that the video can be displayed and played through a set first split screen 201, and an interface of a search application can be displayed through a second split screen 202. The user can operate the display apparatus 200 through a control device 100 or a terminal device 300.

However, with the related art, when the user needs to further obtain media resource information of the currently played video during watching the video, the user needs to manually set the split screen mode, and the operation is cumbersome, reducing user experience.

In order to address the above problem, embodiments of the present disclosure propose a processing method for a display apparatus, for split screen control. The method includes: based on detecting that a target video is being played by a video playing application on the display apparatus, displaying a user prompt interface, where the user prompt interface is used for prompting a user whether to enter a split screen working mode; based on that a command for entering the split screen working mode input from a user on the user prompt interface is received, splitting a display interface of the display apparatus into a first split screen and a second split screen, and starting a search application; and displaying an interface of the video playing application on the first split screen, and displaying an interface of the search application in full screen on the second split screen.

In the method, when the video playing application is detected to play the video, the user prompt interface can be actively displayed for the user, to prompt the user to enter the split screen working mode. When the user determines that media resource information or other information of the target video needs to be obtained, after selecting to enter the split screen working mode, split screen processing is performed on the display interface, and a search application is started simultaneously. The interface of the video playing application is displayed on the first split screen, and the interface of the search application is displayed on the second split screen. Through the method, the user can quickly enter the split screen working mode, the information can also be obtained by searching the application, and the user does not need to manually perform split screen setting on the display interface, improving the user experience.

In some embodiments, the control device 100 can be a remote control. A communication between the remote control and the display apparatus 200 can include an infrared protocol communication, a Bluetooth protocol communication, wireless or other wired methods. The display apparatus 200 can be controlled through the above communication methods. A user can input user commands through keys on the remote control, voice input, and control panel to control the display apparatus 200. For example, a user can input a corresponding control command through a volume up or down key, a menu key, an on-off key and the like on the remote control, to implement a function of controlling the display apparatus 200.

In some embodiments, the display apparatus 200 can also be controlled using a tablet computer, a computer, a notebook computer, and other terminal devices. For example, the display apparatus 200 is controlled using an application running on a terminal device.

In some embodiments, the display apparatus 200 can receive the command not by using the terminal device or the control device described above. Instead, the user's control is received through touch, gesture, or the like.

In some embodiments, the display apparatus 200 can be controlled in a manner other than the control device and the terminal device. For example, voice command control of a user can be directly received through a module for obtaining a voice command configured inside the display apparatus 200. The voice command control of the user can also be received through a voice control device set outside the display apparatus 200.

In some embodiments, the terminal device can install a software application with the display apparatus 200, and implement connection communication through a network communication protocol, to achieve the purpose of one-to-one control operation and data communication. The display apparatus 200 can also communicate data with a server via various communication methods. The display apparatus 200 can be allowed to be communicatively connected via a local region network (LAN), a wireless local region network (WLAN), and other networks. A server can be a cluster or a plurality of clusters, and can include one or more types of servers. The server can provide various contents and interactions to the display apparatus 200. The display apparatus 200 can be a liquid crystal display, an Organic Light Emitting Diode (OLED) display, or a projection display apparatus. In addition to providing a broadcast receiving television function, an intelligent network television function for a computer support function can also be provided additionally.

FIG. 2 is a block diagram of a hardware configuration of a control device 100 according to some embodiments of the present disclosure. As shown in FIG. 2, the control device includes at least one processor 110, a communication interface 130, a user input/output interface 140, a memory, and a power supply. The control device can receive an input operation command from a user and convert the operation command into a command that can be recognized and responded by the display apparatus 200, acting as an intermediary for interaction between the user and the display apparatus 200. The communication interface 130 is configured to communicate with the outside, and includes at least one of a WIFI chip, a Bluetooth module, a Near Field Communication (NFC) module, or an alternative module. The user input/output interface 140 includes at least one of a microphone, a touch pad, a sensor, a key, or an alternative module.

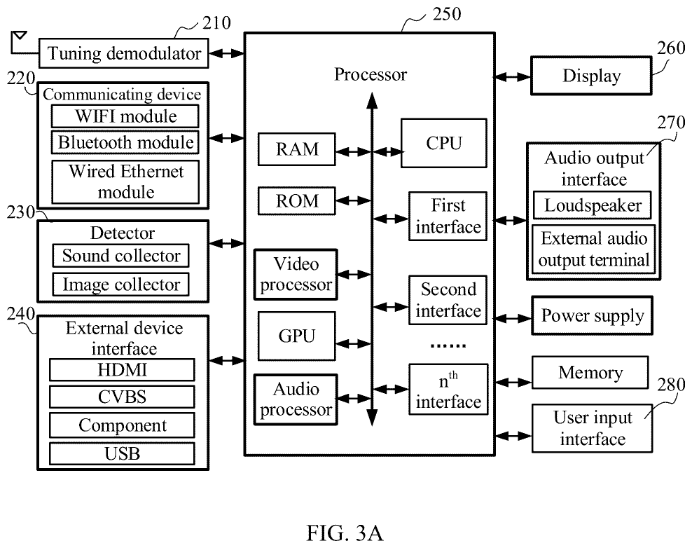

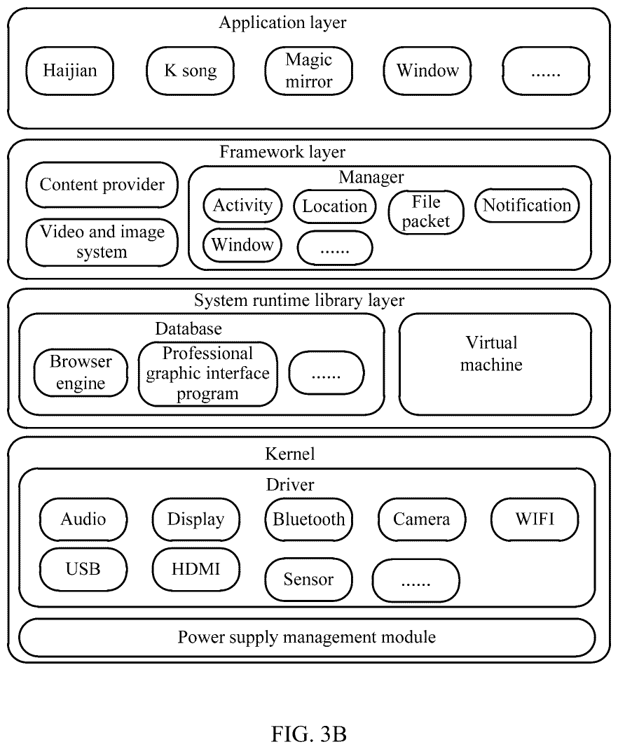

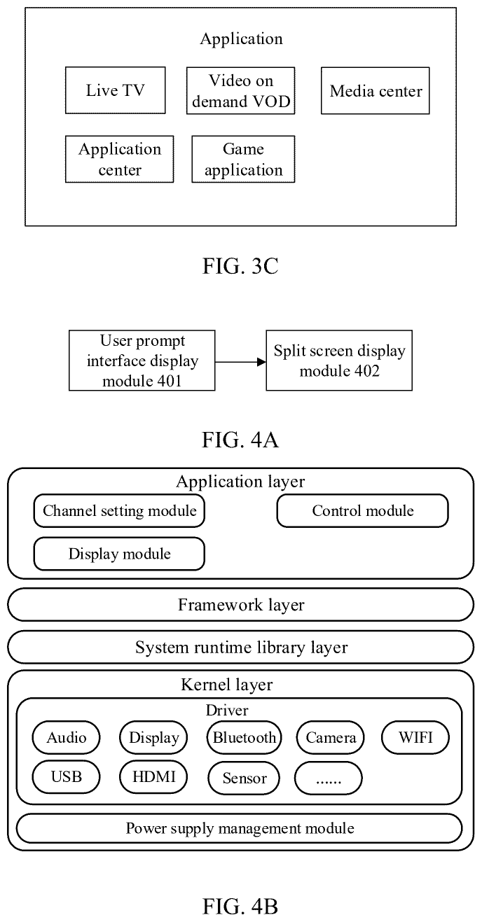

FIG. 3A is a block diagram of a hardware configuration of a display apparatus 200 according to some embodiments of the present disclosure. As shown in FIG. 3A, the display apparatus 200 include a tuning demodulator 210, a communicating device 220, a detector 230, an external device interface 240, at least one processor 250, a display 260, an audio output interface 270, a memory, a power supply, or a user interface (i.e., a user input interface) 280.

The at least one processor 250 includes a central processing unit, a video processor, an audio processor, a Graphics Processing Unit (GPU), a Random Access Memory (RAM), a Read Only Memory (ROM), and first to nth interfaces for input/output, a communication bus, etc.

The display 260 includes a panel component for presenting an image, a driving component for driving image display, a component for receiving an image signal output from the at least one processor, and for presenting video content, image content, a menu operation interface, and a UI interface for user operation, etc. The display 260 can be at least one of a liquid crystal display, an Organic Light Emitting Diode (OLED) display, a touch display, or a projection display. The display 260 can also be a projection apparatus and a projection screen.

The tuning demodulator 210 receives broadcasting television signals through a wired or wireless reception, and demodulates audio-video signals from multiple wireless/wired broadcasting television signals, such as Electronic Program Guide (EPG) data signals.

The communicating device 220 is a component configured to communicate with an external device or a server through various communication protocol types. For example, the communicating device 220 can include at least one of a WIFI module, a Bluetooth module, a wired Ethernet module, other communication protocol chips or a NFC chip, or an infrared receiver. The display apparatus 200 can send and receive control signals and data signals with the control device 100 or the server 400 through the communicating device 220.

The detector 230 is configured to collect external environment signals or signals interacting with the external environment. For example, the detector 230 includes an optical receiver, a sensor configured to collect an intensity of ambience light. Alternatively, the detector 230 includes an image collector, such as a camera, configured to collect an external environment scenario, user attributes or user interaction gestures. Further alternatively, the detector 230 includes a sound collector, such as a microphone and etc., configured to receive external sound.

The external device interface 240 can include at least one of but not be limited to: a High-Definition Multimedia Interface (HDMI), an analog/data high-definition component input interface (Component), a Composite Video Broadcast Signal (CVBS) interface, a Universal Serial Bus (USB) input interface, or an RGB interface. Further, the external device interface 240 can be a composite input/output interface formed by multiple aforementioned interfaces.

The user input interface 280 is configured to receive a control signal from the control device 100 (e.g., an infrared remote control).

The at least one processor 250 and the tuning demodulator 210 can be located in different independent devices, that is, the tuning demodulator 210 can be in an external device of a primary device in which the control device 250 is located, such as an external set-top box and etc.

In some embodiments, the at least one processor 250 controls the operation of the display apparatus and respond to the user operation through various software control programs stored in the memory. The at least one processor 250 controls the overall operation of the display apparatus 200. The user can enter a user command in a graphical user interface (GUI) displayed on the display 260, and the user input interface receives a user input command through the graphical user interface (GUI). Alternatively, the user can enter the user command by entering a particular voice or gesture, and the user input interface recognizes a voice or a gesture through a sensor to receive a user input command.

FIG. 3B is a diagram of a software configuration in a display apparatus 200 according to some embodiments of the present disclosure. As shown in FIG. 3B, a system is divided into four layers from top to bottom, which are applications layer (application layer for short), application framework layer (framework layer for short), android runtime and system library layer (system runtime library layer for short) and Kernel layer.

In some embodiments, at least one application is run in the applications layer. The applications can be Window applications built in the operating system, system setting applications or clock applications and etc., and can be also applications developed by a third party. In an implementation, applications in the application layer include but not limit to aforementioned examples.

The framework layer provides the application programming interface (API) and programming frameworks to the applications in the applications layer. The application framework layer includes some predefined functions. The application framework layer corresponds to a processing center which decides actions of applications in the application layer. The applications can access resources of the system and obtain services from the system through the API.

As shown in FIG. 3B, the application framework layer in embodiments of the present disclosure includes managers, a content provider and etc. The mangers include at least one of an activity manager configured to interact with all running activities, a location manager configured to provide system location service access to the system services or applications, a package manager configured to search various information relating to application packages installed on the device, a notification manager configured to display and remove notification messages, and a window manager configured to manage icons, windows, tool bars, wall papers and desk components on the user interface.

In some embodiments, the activity manager is configured to manage life cycle of an application and normal navigating back functions, such as controlling the functions of exit, open, back of applications, and etc. The window manager is configured to manage all window applications, for examples, obtaining the size of a display window, determining whether there is a status bar, locking screen, capturing screen, controlling a display window to change (e.g. zooming out the display window for display, dithering display, twisted deformation display, etc.).

In some embodiments, the system runtime library supplies supports to a high layer, i.e., the framework layer. When the framework layer is used, the Android operation system runs C/C++ library included in the system runtime library layer to achieve functions of the framework layer.

In some embodiments, the Kernel layer is a layer between hardware and software, the Kernel layer includes at least one of drivers: an audio driver, a display driver, a Bluetooth driver, a camera driver, a WIFI driver, a USB driver, an HDMI driver, a sensor driver (such as a fingerprint sensor, a temperature sensor, a pressure sensor and etc.), or a power-supply driver, etc.

FIG. 3C is a schematic diagram of an icon control interface of an application in a display apparatus 200 according to some embodiments of the present disclosure. As shown in FIG. 3C, the application layer includes a corresponding icon control that can be displayed on a display for at least one application, such as a live TV application icon control, a video-on-demand application icon control, a media center application icon control, an application center icon control, a game application icon control, etc. A live TV application provides live TV programs from different signal sources. A video-on-demand application can provide videos from different storage sources. Unlike the live TV application, the video-on-demand application provides videos from some storage sources for display. A media center application can provide a variety of multimedia content for playback. An application center can provide storage for various applications.

In some embodiments, the display apparatus is a terminal device having a display function, for example, a television, a mobile phone, a computer, a learning machine, etc. The display apparatus includes following components.

A display 260 is configured to display an image and/or a user interface.

A user input interface 280 is configured to receive a command from a user.

A communicating device (communicating device 220) is configured to communicate with an external device according to a predetermined protocol.

A memory is configured to store computer instructions and data associated with the display apparatus.

At least one processor 250 is in connection with the display 260, the user input interface 280, the communicating device and the memory, and configured to execute computer instructions to cause the display apparatus to perform: based on detecting that a target video is being played by a video playing application on the display apparatus, displaying a user prompt interface, where the user prompt interface is used for prompting a user whether to enter a split screen working mode; based on that a command for entering the split screen working mode input from a user on the user prompt interface is received, splitting a display interface of the display apparatus into a first split screen and a second split screen, and starting a search application; and displaying an interface of the video playing application on the first split screen, and displaying an interface of the search application in full screen on the second split screen.

In some embodiments, the at least one processor 250 is configured to execute computer instructions to cause the display apparatus to perform: obtaining a size of a preset display interface of the video playing application and a size of a first display interface of the first split screen, where the preset display interface is an interface for displaying the target video; determining a size of a target display interface for displaying the video playing application on the first split screen based on the size of the preset display interface and the size of the first display interface; and displaying an interface of the video playing application on the first split screen based on the size of the target display interface.

In some embodiments, the at least one processor 250 is further configured to execute computer instructions to cause the display apparatus to perform: determining a target ratio according to the size of the preset display interface; and determining the size of the target display interface for displaying the video playing application on the first split screen according to the size of the first display interface and the target ratio.

In some embodiments, the at least one processor 250 is configured to execute computer instructions to cause the display apparatus to perform: determining a size of a second display interface of the second split screen; and displaying the interface of the search application in full screen on the second split screen based on the size of the second display interface.

In some embodiments, the at least one processor 250 is further configured to execute computer instructions to cause the display apparatus to perform: in response to a search command input from a user, displaying a keyword menu; and based on that a selection command for a keyword input from a user in the keyword menu is received, invoking the search application, and obtaining media resource information of the target video.

In some embodiments, the at least one processor 250 is configured to execute computer instructions to cause the display apparatus to perform: in response to the search command input from the user, obtaining attribute information of the target video; and generating the keyword menu based on the attribute information.

In some embodiments, the at least one processor 250 is further configured to execute computer instructions to cause the display apparatus to perform: based on that a command for starting a preset application input from a user is received, exiting the split screen working mode, and displaying the preset application on the display interface.

To sum up, by executing the processing method for the display apparatus on the display apparatus, a user prompt interface is displayed based on detecting that a target video is being played by a video playing application on the display apparatus. The user prompt interface is used for prompting a user whether to enter a split screen working mode. Based on that a command for entering the split screen working mode input from a user on the user prompt interface is received, a display interface of the display apparatus is split into a first split screen and a second split screen, and a search application is started. An interface of the video playing application is displayed on the first split screen, and an interface of the search application is displayed in full screen on the second split screen. In the method, when detecting that the video playing application is playing the video, the user prompt interface can be actively displayed for the user, to prompt the user to enter the split screen working mode. When the user determines that media resource information or other information of the target video needs to be obtained, after selecting to enter the split screen working mode, split screen processing is performed on the display interface, and the search application is started simultaneously. The interface of the video playing application is displayed on the first split screen, and the interface of the search application is displayed on the second split screen. Through the method, the user can quickly enter the split screen working mode, the information can also be obtained by searching the application during watching the video, the user does not need to manually perform split screen setting on the display interface, and the user experience is improved.

FIG. 4A is a block diagram of a system for split screen control according to some embodiments of the present disclosure. As shown in FIG. 4A, the system can include a user prompt interface display module 401 and a split screen display module 402. When the system detects that a target video is being played by a video playing application on the display apparatus, a user prompt interface is displayed by the user prompt interface display module 401. The user prompt interface is used for prompting a user whether to enter a split screen working mode. When a command for entering the split screen working mode input from a user on the user prompt interface is received, the split screen display module 402 splits a display interface of the display apparatus into a first split screen and a second split screen, starts a search application, displays an interface of the video playing application on the first split screen, and displays an interface of the search application in full screen on the second split screen. In the method, when detecting that the video playing application is playing the video, the user prompt interface can be actively displayed for the user, to prompt the user to enter the split screen working mode. When the user determines that media resource information or other information of the target video needs to be obtained, after selecting to enter the split screen working mode, split screen processing is performed on the display interface, and the search application is started simultaneously. The interface of the video playing application is displayed on the first split screen, and the interface of the search application is displayed on the second split screen. Through the method, the user can quickly enter the split screen working mode, the information can also be obtained by searching the application during watching the video, the user does not need to manually perform split screen setting on the display interface, and the user experience is improved.

FIG. 4B is an architecture diagram of split screen control according to some embodiments of the present disclosure. Based on the above system framework, the present disclosure is implemented as shown in FIG. 4B. An android system mainly includes application layer, framework layer, system runtime library layer and kernel layer. Implementation logic is mainly embodied in the application layer including a user prompt interface display module and a split screen display module. Functions of each module have been described in detail above embodiments, and are not described here to avoid repetition.

According to the processing method for the display apparatus according to embodiments of the present disclosure, when detecting that a target video is being played by a video playing application on the display apparatus, the at least one processor of the display apparatus displays a user prompt interface. The user prompt interface is used for prompting a user whether to enter a split screen working mode. When a command for entering the split screen working mode input from a user on the user prompt interface is received, the at least one processor of the display apparatus splits a display interface of the display apparatus into a first split screen and a second split screen, starts a search application, displays an interface of the video playing application on the first split screen, and displays an interface of the search application in full screen on the second split screen. In the method, when detecting that the video playing application is playing the video, the user prompt interface can be actively displayed for the user, to prompt the user to enter the split screen working mode. When the user determines that media resource information or other information of the target video needs to be obtained, after selecting to enter the split screen working mode, split screen processing is performed on the display interface, and the search application is started simultaneously. The interface of the video playing application is displayed on the first split screen, and the interface of the search application is displayed on the second split screen. Through the method, the user can quickly enter the split screen working mode, the information can also be obtained by searching the application during watching the video, the user does not need to manually perform split screen setting on the display interface, and the user experience is improved.

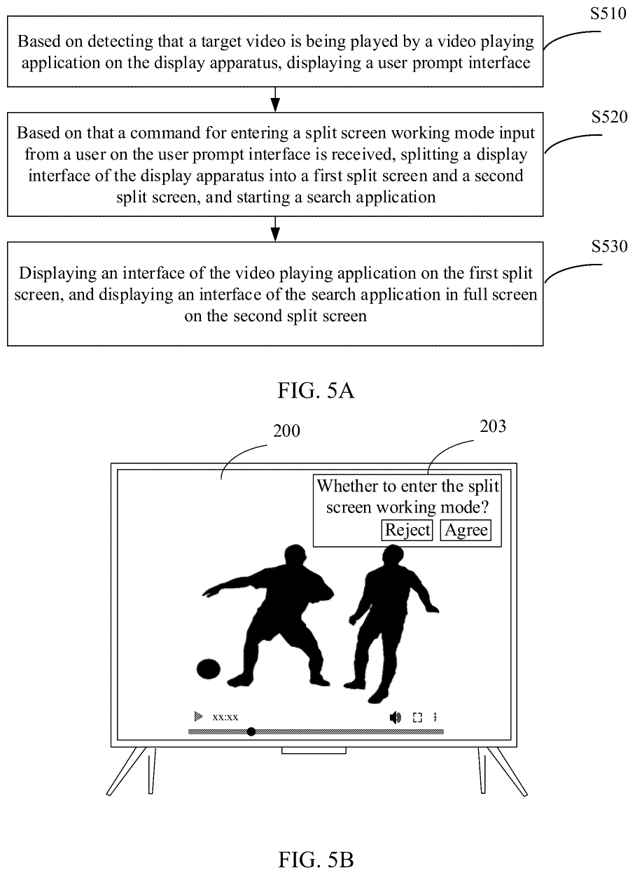

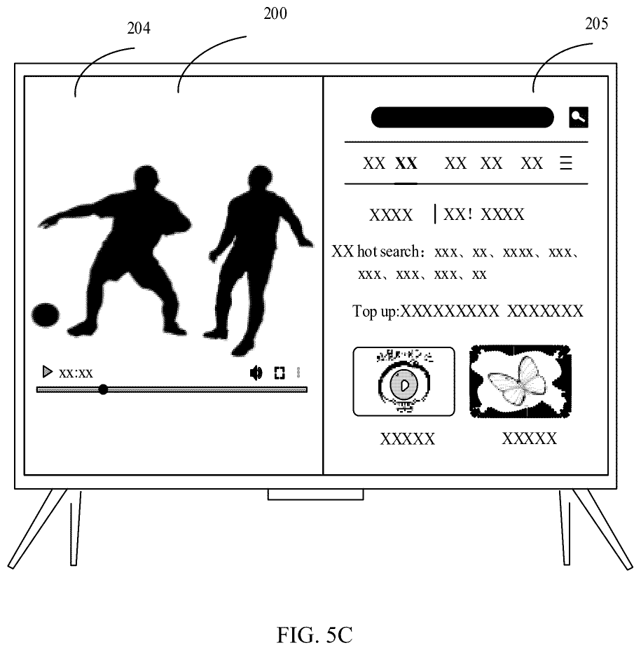

For a more detailed description of embodiments, reference is now made to FIG. 5A. It should be noted that, steps referred to in FIG. 5A can include more steps or fewer steps in an actual implementation, and the order between these steps can also be different, to implement the processing method for the display apparatus according to embodiments of the present disclosure, and embodiments of the present disclosure are not limited thereto.

FIG. 5A is a first flowchart of a processing method for a display apparatus according to some embodiments of the present disclosure. As shown in FIG. 5A, the method includes following steps.

S510: Based on detecting that a target video is being played by a video playing application on the display apparatus, displaying a user prompt interface.

The user prompt interface is used for prompting a user whether to enter a split screen working mode. The target video can be a locally saved video or a video downloaded from the network, but is not limited thereto, which is not limited in the present disclosure.

When at least one processor of the display apparatus detects that a target video is being played by a video playing application on the display apparatus, a user prompt interface is displayed on a display interface of the display apparatus 200 to prompt a user whether to enter a split screen working mode.

As shown in FIG. 5B, when at least one processor of the display apparatus 200 detects that a target video is being played by a video playing application on the display apparatus 200, a user prompt interface 203 is displayed on a display interface of the display apparatus 200. A prompt of “whether to enter a split screen working mode” is displayed on the user prompt interface 203, so that a user can determine whether to cause the display interface of the display apparatus to enter a split screen working mode quickly according to his/her own will.

It should be noted that the user prompt interface can be a prompt interface popped up on the video playing application or a menu, and can also be a floating window floating on the video playing application, but it is not limited to this, which is not limited in the present disclosure. Those skilled in the art can set according to actual situations.

Optionally, the detecting that a target video is being played by a video playing application on the display apparatus can be that: when a playing window corresponding the video playing application is displayed on the display interface, it is considered that the current video playing application is playing the target video, but it is not limited to this, which is not limited in the present disclosure. Those skilled in the art can set according to actual situations.

S520: Based on that a command for entering a split screen working mode input from a user on the user prompt interface is received, splitting a display interface of the display apparatus into a first split screen and a second split screen, and starting a search application.

When a current user determines that he/she needs to obtain media resource information of the target video played by the video playing application, or he/she needs to know other information, the user inputs a command for entering a split screen working mode on a user prompt interface.

When at least one processor of the display apparatus receives a command for entering a split screen working mode input from a user, the at least one processor of the display apparatus splits a display interface of the display apparatus into a first split screen and a second split screen, and starts a search application simultaneously.

It should be noted that, in this case, split screen processing is performed on the display interface of the display apparatus to obtain a first split screen and a second split screen. In order to enable the first split screen and the second split screen to have the largest display interface, there is no interval between the first split screen and the second split screen, and both the first split screen and the second split screen are half of the display interface of the display apparatus, but are not limited thereto. A layout of the first split screen and the second split screen on the display interface is not limited in the present disclosure. Those skilled in the art can set according to actual situations.

S530: Displaying an interface of the video playing application on the first split screen, and displaying an interface of the search application in full screen on the second split screen.

After splitting the display interface of the display apparatus into the first split screen and the second split screen, the at least one processor of the display apparatus displays an interface of the video playing application on the first split screen, that is, the target video currently being played by the video playing application is displayed on the first split screen, and an interface of the search application is displayed in full screen on the second split screen.

Following the above embodiment, as shown in FIG. 5B to FIG. 5C, on the user prompt interface, the user can determine whether to cause the display interface of the display apparatus 200 to enter the split screen working mode according to his/her own will. When the user clicks a virtual key “agree”, the display interface of the display apparatus 200 is split into the first split screen 204 and the second split screen 205, and the search application is started simultaneously. The interface of the video playing application is displayed on the first split screen 204, that is, the target video currently being played by the video playing application is displayed on the first split screen 204. The interface of the search application is displayed in full screen on the second split screen 205.

In embodiments of the present disclosure, when detecting that a target video is being played by a video playing application on the display apparatus, the at least one processor of the display apparatus displays a user prompt interface. The user prompt interface is used for prompting a user whether to enter a split screen working mode. When a command for entering the split screen working mode input from a user on the user prompt interface is received, the at least one processor of the display apparatus splits a display interface of the display apparatus into a first split screen and a second split screen, starts a search application, displays an interface of the video playing application on the first split screen, and displays an interface of the search application in full screen on the second split screen. In the method, when detecting that the video playing application is playing the video, the user prompt interface can be actively displayed for the user, to prompt the user to enter the split screen working mode. When the user determines that media resource information or other information of the target video needs to be obtained, after selecting to enter the split screen working mode, split screen processing is performed on the display interface, and the search application is started simultaneously. The interface of the video playing application is displayed on the first split screen, and the interface of the search application is displayed on the second split screen. Through the method, the user can quickly enter the split screen working mode, the information can also be obtained by searching the application during watching the video, the user does not need to manually perform split screen setting on the display interface, and the user experience is improved.

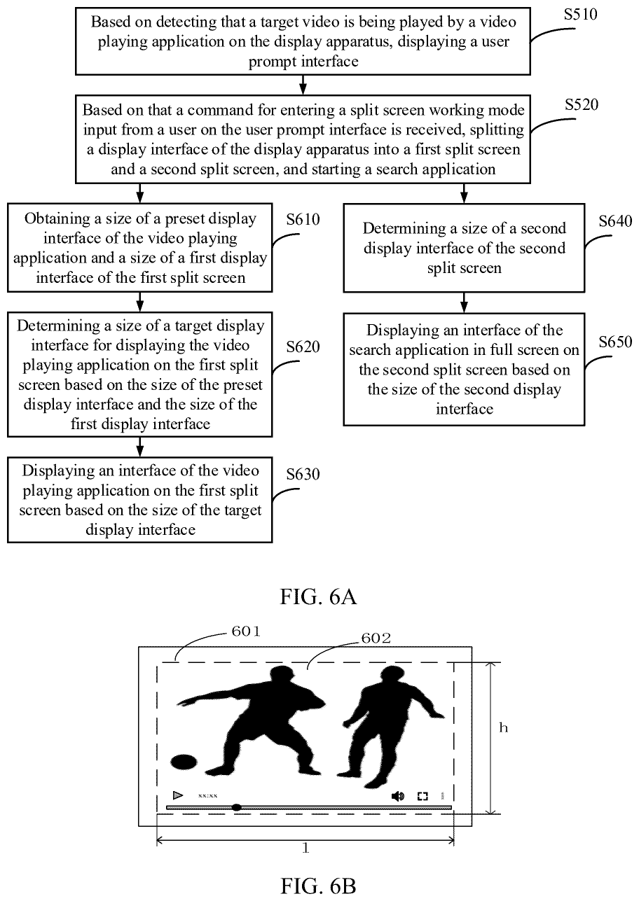

FIG. 6A is a second flowchart of a processing method for a display apparatus according to some embodiments of the present disclosure. FIG. 6A is based on embodiments shown in FIG. 5A. Further, as shown in FIG. 6A, a possible implementation of displaying the interface of the video playing application on the first split screen is as follows.

S610: Obtaining a size of a preset display interface of the video playing application and a size of a first display interface of the first split screen.

The preset display interface is an interface for displaying the target video. It should be noted that the preset display interface here is an interface of an image corresponding to the target video played through the video playing application before the display apparatus splits the screen. as shown in FIG. 6B, for the entire window interface 601 corresponding to the video playing application, an interface 602 of the target video played in the window interface 601 is the preset display interface, but is not limited thereto, and is not limited in the present disclosure.

S620: Determining a size of a target display interface for displaying the video playing application on the first split screen based on the size of the preset display interface and the size of the first display interface.

The at least one processor of the display apparatus obtains the size of the preset display interface of the video playing application, and the size of the first display interface of the first split screen. After the size of the preset display interface of the video playing application and the size of the first display interface of the first split screen are obtained, the size of the target display interface for displaying the video playing application on the first split screen is determined according to the size of the preset display interface of the video playing application and the size of the first display interface of the first split screen.

Optionally, on the basis of the above embodiments, in some embodiments of the present disclosure, an implementation of S620 can be as follows.

S6201: Determining a target ratio according to the size of the preset display interface.

The size of the preset display interface can be a length and height of the interface for displaying the target video. As shown in FIG. 6B, for the preset display interface 602, the corresponding size is the length l and the height h. According to the size of the preset display interface, i.e., the length and the height, a corresponding target ratio such as l:h is determined, and the target ratio can be, for example, 16:9 or 4:3, but is not limited thereto, and is not limited in the present disclosure. Those skilled in the art can set according to actual situations.

Optionally, the size of the first display interface of the first split screen can be determined according to pixel points of the first split screen. The size of the preset display interface can be determined according to pixel points of the image corresponding to the target video currently being played, but is not limited thereto, and is not limited in the present disclosure. Those skilled in the art can set according to actual situations.

S6202: Determining the size of the target display interface for displaying the video playing application on the first split screen according to the size of the first display interface and the target ratio.

The size of the target display interface refers to the size of the interface that can maximally display the image of the target video on the first split screen after the screen is split.

After obtaining the size of the preset display interface, the at least one processor of the display apparatus determines the target ratio of the interface for displaying the target video according to the size of the preset display interface. After the target ratio of the interface for displaying the target video is determined, the at least one processor of the display apparatus determines the size of the target display interface for displaying the video playing application on the first split screen according to the size of the first display interface and the target ratio.

S630: Displaying an interface of the video playing application on the first split screen based on the size of the target display interface.

After obtaining the size of the target display interface according to the size of the first display interface and the target ratio, the at least one processor of the display apparatus displays the interface of the video playing application on the first split screen based on the size of the target display interface.

In embodiments of the present disclosure, in the above process, the size of the display interface of the first split screen and the target ratio determined according to the size of the preset display interface of the video playing application are used to determine the size of the interface of the video play application displayed on the first split screen, the target video played by the current video playing application can be maximally displayed to the user, so that the user experience is improved.

Optionally, on the basis of the above embodiments, in some embodiments of the present disclosure, continuing to refer to FIG. 6A, an implementation of displaying the interface of the search application in full screen on the second split screen can be as follows.

S640: Determining a size of a second display interface of the second split screen.

S650: Displaying an interface of the search application in full screen on the second split screen based on the size of the second display interface.

The at least one processor of the display apparatus obtains a size of a second display interface of the second split screen. After the size of the second display interface of the second split screen is obtained, the interface corresponding to the search application is displayed in full screen on the second split screen.

Continuing to refer to above embodiments, as shown in FIG. 5C, for the second split screen 205, after the size of the second display interface of the second split screen 205 is obtained, the interface corresponding to the search application can be displayed in full screen on the second split screen 205, but is not limited thereto, and is not limited in the present disclosure. Those skilled in the art can set according to actual situations.

In embodiments of the present disclosure, in the above process, the interface corresponding to the search application is displayed on the second split screen in full screen by using the size of the interface of the second split screen. Therefore, the interface corresponding to the search application can be maximally displayed to the user on the second split screen, and the user experience is improved.

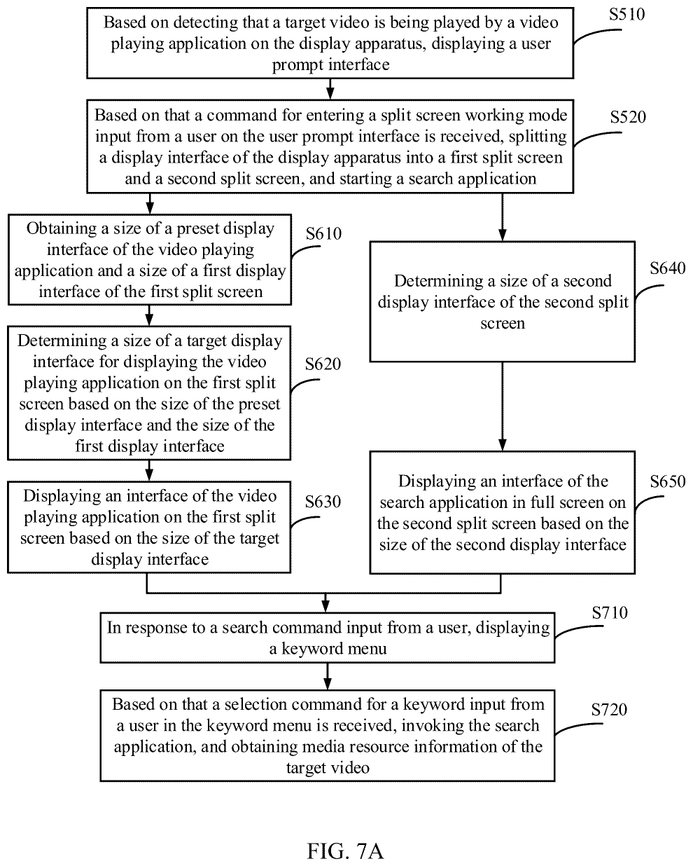

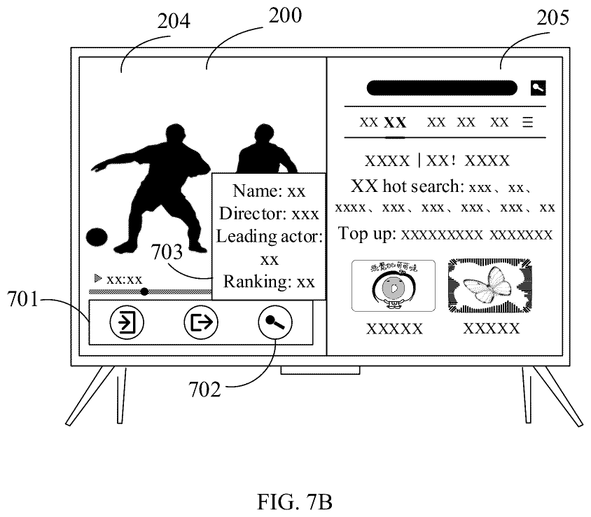

FIG. 7A is a third flowchart of a processing method for a display apparatus according to some embodiments of the present disclosure. FIG. 7A is on the basis of embodiments shown in FIG. 6A. As shown in FIG. 7A, in order to enable a user to quickly obtain media resource information of a target video currently being played by a video playing application on a display apparatus, an implementation can be as follows.

S710: In response to a search command input from a user, displaying a keyword menu.

The search command is used for indicating a command input when a user currently wants to obtain the media resource information related to the target video. The keyword menu includes attribute information corresponding to the target video, such as a name of the target video, ranking of the target video, a type of the target video, a director of the target video, and a leading actor of the target video, but is not limited thereto, and is not limited in the present disclosure. Those skilled in the art can set according to actual situations.

The at least one processor of the display apparatus is configured to receive a search command input from a user, and in response to the search command from the user, display a keyword menu related to the target video to the user.

With reference to FIG. 7B, the search command input from the user can be to click a virtual key 702 such as “search” on a sub-menu 701 on the first split screen interface. When the user clicks the virtual key 702 “search”, a keyword menu 703 is displayed on the interface corresponding to the video playing application, but is not limited thereto, and is not limited in the present disclosure.

Those skilled in the art can set according to actual situations.

Optionally, on the basis of the above embodiments, in some embodiments of the present disclosure, an implementation of obtaining a keyword menu can be as follows.

Attribute information of the target video is obtained in response to a search command input from a user.

The attribute information of the target video includes, but is not limited to, the name of the target video, the ranking of the target video such as top 10, the type of the target video such as comedy, horror or adventure, and a score of the target video such as 8.6, the director of the target video and the leading actor of the target video, which are not limited in the present disclosure. Those skilled in the art can set according to actual situations.

Optionally, the attribute information of the target video can be obtained through an electronic program guide, but is not limited thereto, and is not limited in the present disclosure. Those skilled in the art can set according to actual situations.

A keyword menu is generated based on the attribute information.

The at least one processor of the display apparatus receives a search command input from a user, and in response to the search command of the user, obtains the attribute information of the target video currently being played, extracts a plurality of keywords from the attribute information to generate a keyword menu after obtaining the attribute information of the target video currently being played, and displays a keyword menu related to the target video to the user.

S720: Based on that a selection command for a keyword input from a user in the keyword menu is received, invoking the search application, and obtaining media resource information of the target video.

On a keyword menu related to the target video, a user selects from a plurality of keywords according to his/her own will, and determines one or more keywords. After determining the one or more keywords, the at least one processor of the display apparatus invokes a search application to search according to the one or more keywords to obtain the media resource information of the target video.

Continuing to refer to above embodiments, with further reference to FIG. 7B, after a keyword “name: XX” is selected in the keyword menu 703, the search application is invoked to search according to the keyword “name: XX” to obtain the media resource information of the target video.

In embodiments of the present disclosure, in the above process, when the user wants to know more about the media resource information of the currently played target video, the user can directly obtain a keyword menu related to the target video through inputting a search command, so that the user can select one or more keywords based on the keyword menu, to perform a search based on the one or more keywords using the search application. Through the method, the media resource information of the currently played target video can be quickly obtained by a user without manually inputting a search cluster, improving the user experience.

Optionally, on the basis of the above embodiments, some embodiments of the present disclosure further include: based on that a command for starting a preset application input from a user is received, exiting the split screen working mode, and displaying the preset application on the display interface.

The preset application refers to other applications that are not running, for example, an audio playing application, and can also be a shortcut key preset for the current display apparatus, but is not limited thereto, and is not limited in the present disclosure. Those skilled in the art can set according to actual situations.

When at least one processor of the display apparatus receives a command for starting a preset application input from a user, in response to the command, the split screen working mode is exited, and the preset application is displayed to the user on the display interface of the display apparatus.

Optionally, on the basis of the above embodiments, in some embodiments of the present disclosure, an implementation of exiting the split screen working mode can also be that an exit shortcut key is preset, so that a user can quickly exit the split screen working mode based on the exit shortcut key and return to an interface of a focus application.

It should be noted that the focus application refers to an application that can be controlled by a current user. The focus application can be a video playing application or a search application. Determination of the focus application can be implemented based on a selection command input from a user. For example, a user can click a virtual key “R” on a preset menu to determine that the focus application is a search application, or click a virtual key “L” to determine that the focus application is a video playing application, but is not limited thereto, and is not limited in the present disclosure. Those skilled in the art can set according to actual situations.

In embodiments of the present disclosure, in the above process, when the display apparatus works in the split screen working mode, based on that a command for starting another preset application input from a user or a command for exiting the split screen working mode is received, the user can quickly exit the split screen working mode, and the user experience is improved.

At present, when a user uses a display apparatus for fitness training, a split screen mode of the display apparatus needs to be started first, then a fitness teaching APP is started and a fitness teaching video is played in the split screen mode. It is impossible to start the split screen mode immediately after start of the fitness teaching APP or during playback of the fitness teaching video. As a result, the user's performance is poor.

In order to improve the user experience, embodiments of the present disclosure provide a second processing method for a display apparatus, for display control, so that when the display apparatus plays the fitness teaching video, the split screen mode can be started in real time, and then the user experience is improved.

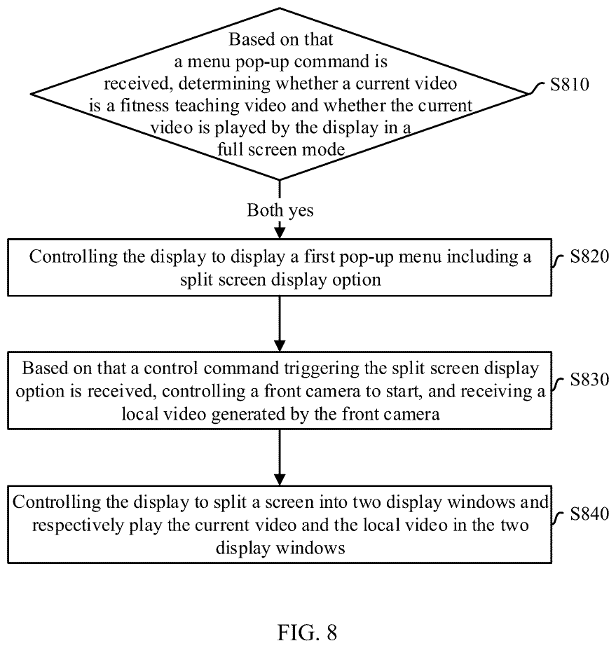

FIG. 8 is a first flowchart of a second processing method for a display apparatus according to some embodiments of the present disclosure. The method illustrated in FIG. 8 is performed by at least one processor in the display apparatus. As shown, the method performed by the at least one processor includes S810 to S850.

S810: Based on that a menu pop-up command is received, determining whether a current video is a fitness teaching video and whether the current video is played by the display in a full screen mode; when the current video is the fitness teaching video and the current video is played by the display in the full screen mode, performing S820.

In embodiments of the present disclosure, after a user starts a display apparatus and sends a video playing command to the display apparatus, the display apparatus starts playing a video file corresponding to a current video, to achieve playing of the current video on the display. In other embodiments, the at least one processor can use a client application, such as Youtube, to obtain and parse a current video provided by a remote server, to achieve playing of the current video on the display. In other embodiments, the at least one processor can also receive a video stream sent from other intelligent terminals, parse the video stream and achieve playing of the current video on the display.

When the display apparatus plays the current video, a user can send a menu pop-up command to at least one processor of the display apparatus through a remote control, a terminal device or gesture control.

When at least one processor receives a menu pop-up command triggered by a user, rather than determining types of options included in a pop-up menu from a pre-configured template in a conventional manner, and loading corresponding options and controlling the display to display the pop-up menu, but firstly determining whether the current video is a fitness teaching video and whether the current video is played by the display in a full screen mode, and determining types of options included in the pop-up menu according to a determination result, and displaying the pop-up menu.

In a specific implementation of embodiments of the present disclosure, the at least one processor can employ different methods to determine whether the current video being played on the display is a fitness teaching video.

In some embodiments, when the display apparatus plays the current video using the client application, the at least one processor can determine whether the current video is the fitness teaching video by obtaining a type identification of the current video provided by the client application or according to a network address of a video stream of the current video provided by the client application.

In yet further embodiments, the at least one processor is configured with a pre-trained video type recognition model. The video type recognition model can determine a type of a video by processing video frames. The at least one processor can intercept a video frame of the current video and recognize the current video using the video type recognition model, and determine whether the current video is a fitness teaching video.

In embodiments of the present disclosure, the at least one processor can determine whether the current video is played by the display in a full screen mode by invoking a playback window configuration parameter.

S820: Controlling the display to display a first pop-up menu including a split screen display option.

When the at least one processor determines that the current video is a fitness teaching video and the current video is played by the display in a full screen mode, the control device controls the display to display a first pop-up menu including a split screen display option.

In a particular implementation, the at least one processor can obtain a default option and the split screen display option included in the first pop-up menu based on that a current video is being played by the display, reasonably arrange the default option and the split screen display option to determine a display style of the first pop-up menu, and control the display to display the first pop-up menu according to the display style.

In some embodiments of the present disclosure, at least one processor can invoke a WindowsManager method provided by an operating system, to display the first pop-up menu in a currently displayed window (i.e., a window in which the current video is played) of the display.

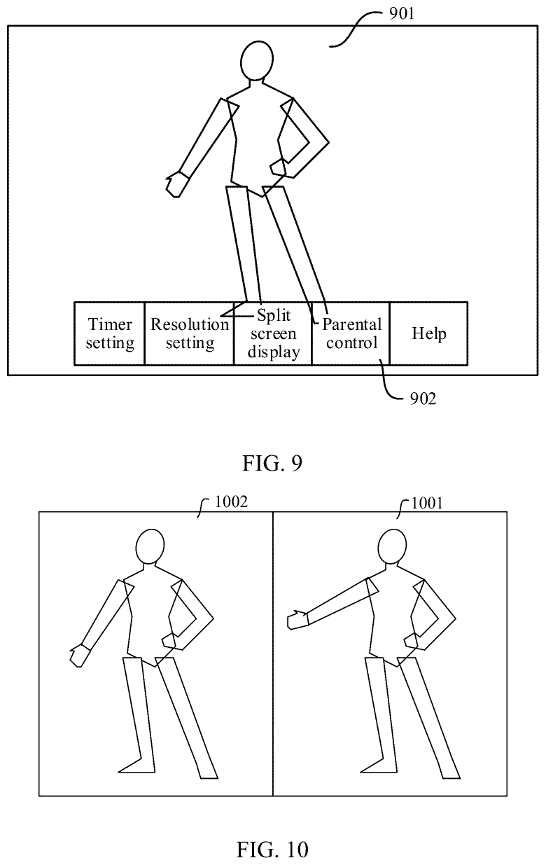

FIG. 9 is a schematic diagram of a user interface of a display in a case according to some embodiments of the present disclosure. As shown in FIG. 9, when the at least one processor controls the display to display the first pop-up menu 902, the first pop-up menu 902 is displayed in a floating manner in the currently displayed window 901. The first pop-up menu 902 is displayed on a lower side of the currently displayed window 901 in order to make the user interface aesthetic. The first pop-up menu 902 includes a split screen display option and the split screen display option is displayed in a highlighted manner, that is, the split screen display option is in a selected state. Referring to FIG. 9, the first pop-up menu 902 includes a timer setting option, a resolution setting option, a parental control option, and a help option, in addition to the split screen display option.

It should be noted that in embodiments of the present disclosure, only when the current video is a fitness teaching video and the current video is played by the display in a full screen mode, the split screen display option is added to the first pop-up menu 902. When the current video is not a fitness teaching video, or the current video is not played by the display in a full screen mode, the split screen display option is not included in the first pop-up menu 902.

S830: Based on that a control command triggering the split screen display option is received, controlling a front camera to start, and receiving a local video generated by the front camera.

After the first pop-up menu 902 is displayed on the display, the user can see various selectable options in the first pop-up menu 902. When the user wants to control the display apparatus to start the split screen display mode, a control command for triggering the split screen display option can be sent to at least one processor using a remote control, a terminal device, or gesture control.

After the at least one processor receives a control command triggering the split screen display option from a user, the at least one processor controls the front camera to initialize and photograph an environment at a display side of the display after the initialization is successful, to obtain a local video. It should be noted that the front camera mentioned in embodiments of the present disclosure is a camera photographing an environment at a display side of the display. In some embodiments, the camera configured for the display apparatus is a rotatable camera. In this case, the camera can be identified as a front camera only when a lens of the camera faces the display side of the display. When the rotatable camera is facing a non-display side of the display, the camera is no longer treated as a front camera and is therefore not started.

In specific embodiments, the at least one processor can start the front camera by invoking a camera driving method provided by a bottom layer of the operating system, and receive a local video photographed by the front camera through a corresponding interface.

S840: Controlling the display to split a screen into two display windows and respectively play the current video and the local video in the two display windows.

At least one processor determines that the front camera is started successfully after receiving the local video returned by the front camera, and returns the local video normally. The at least one processor can then use a display window control method provided by the operating system to split the display interface of the display into two display windows, and respectively play that current video and the local video in the two display windows.

It should be noted that when the front camera does not start normally, at least one processor cannot be able to get a local video. In order to avoid that a display window has no corresponding display video after the screen is split, the at least one processor does not control split of the display screen into two display windows.

FIG. 10 is a schematic diagram of a user interface displayed by a display in another case according to some embodiments of the present disclosure. As shown in FIG. 10, the display interface of the display is split into two display windows on left and right equally. The two display windows are a first display window 1001 on the right and a second display window 1002 on the left. The first display window 1001 plays the local video returned by the front camera, and the second display window 1002 plays the current video. Because the current video is a fitness teaching video, and the local video is a follow-up video of photographing the user's body movements, when the user follows the fitness teaching video for fitness, the user can view the fitness teaching video and the follow-up video simultaneously, and determine whether his/her actions are correct and standardized.

As before, by adopting the second processing method for the display apparatus according to embodiments of the present disclosure, after receiving the menu pop-up command, the at least one processor determines whether the current video played by the display is a fitness teaching video and whether the current video is played by the display in a full screen mode. When the current video played by the display is a fitness teaching video and the fitness teaching video is played in a full screen mode, the first pop-up menu controlled to be displayed by the display includes a split screen display option. When a user triggers the split screen display option, the at least one processor controls the front camera to start photographing a local video, and enables the display to respectively play the current video and the local video in the two display windows in a split screen display mode.

By adopting the second processing method for the display apparatus according to embodiments of the present disclosure, when the display apparatus plays the fitness teaching video and the user wants to trigger the display to display the local video of follow-up training in a split screen, the at least one processor provides a first pop-up menu including a split screen display option, which is convenient for the user to quickly switch a playing mode of the display to a split screen display mode for follow-up training when the fitness video is played, and that us experience is improved.

In some embodiments of the present disclosure, after the at least one processor controls the display to respectively play the current video and the local video in the two display windows, the user can also send a menu pop-up command to the at least one processor again for various reasons. In this case, the at least one processor can, in addition to performing S810 to S840, perform following S850 to S860 after performing S840.

S850: Based on that the menu pop-up command is received again, controlling the display to display a second pop-up menu including a mirroring option in a first display window for playing the local video.

In some embodiments of the present disclosure, the at least one processor, upon receiving the menu pop-up command again, loads preconfigured types of options and invokes the WindowsManager method provided by the operating system, to display a second pop-up menu 1003 in the first display window 1001.

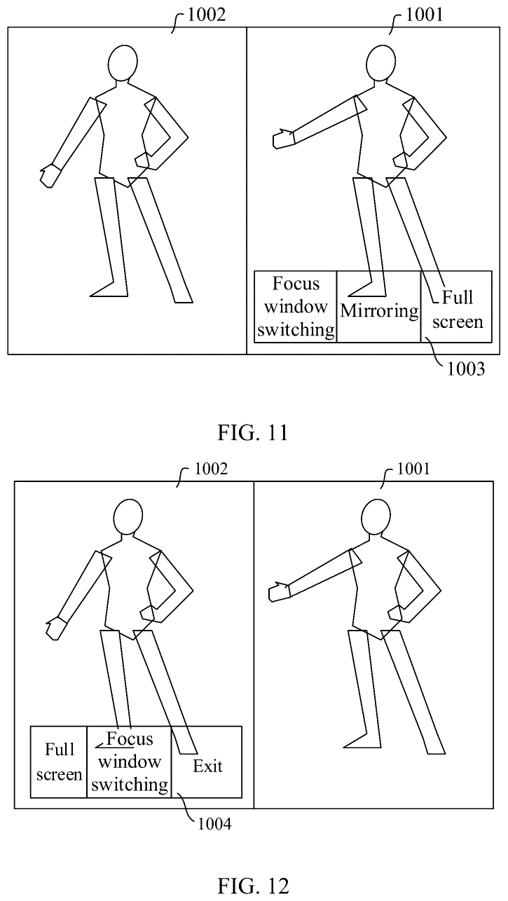

FIG. 11 is a schematic diagram of a user interface displayed by a display in another case according to some embodiments of the present disclosure. As shown in FIG. 11, when the at least one processor controls the display to display the second pop-up menu 1003, the second pop-up menu 1003 is displayed in the first display window 1001 in a floating display mode. As shown in FIG. 11, a mirroring option is included in the first pop-up menu, and the mirroring option is in a selected state. The mirroring option is an option for triggering the local video displayed in the first display window 1001 to be mirror flipped left and right.

In some embodiments, a user's body posture in the local video displayed in the first display window 1001 is opposite to a coach's posture in the fitness teaching video played in the second display window 1002. In this case, it is not convenient for the user to quickly identify whether his/her own follow-up movements are correct. In order to facilitate the user to conveniently compare whether the action of the user is consistent with the action of the coach, and then confirm whether the follow-up action is correct, the user has the need to trigger the current video to be mirror flipped. In order to meet the requirement of the user, in embodiments of the present disclosure, the mirroring option is displayed in the second pop-up menu 1003.

S860: Based on that a control command triggering the mirroring option is received, horizontally mirror flipping the local video, and controlling the display to play the local video horizontally mirror flipped in the first display window.

When the user wants to mirror flip the local video left and right, a control command triggering the mirroring option can be sent to the at least one processor of the display apparatus through a remote control, a terminal device, or gesture control.

After the at least one processor receives the control command triggering the mirroring option, the at least one processor can get the video frame of the local video in an OnPreviewFrame method provided by the operating system, and invoke a preset mirror flipping algorithm to perform mirror flipping on the video frame to obtain the local video mirror flipped. After getting the local video mirror flipped, the at least one processor controls the display to play the local video horizontally mirror flipped in the first display window 1001.

For difference of a data storage type and a color mode type of the video frame in the local video, at least one processor needs to adopt a corresponding data processing algorithm to process the video frame to obtain the video frame mirror flipped. How to realize mirror flipping of various types of video frames can be found in the relevant technical literature, which will not be expanded here.

In some embodiments of the present disclosure, the local video photographed by the front camera is a video in a YUV color mode, and the video frame is stored using a yuvbyte array. For this type of local video, the at least one processor uses the following program code to implement the mirror flipping of each video frame in the local video:

```
  private void Mirror(byte[ ] src, int w, int h) { //src is an original yuv
  array
    int i,index, int a, b;byte temp;
    for (i = 0; i < h; i++) {
      a = i * w;
      b = (i + 1) * w − 1;
      while (a < b) {
        temp = src[a];
        src[a] = src[b];
        src[b] = temp;
        a++;
        b−−;
      }
    } //mirror y
  index = w * h;//U an initial position
    for (i = 0; i < h / 2; i++) {
      a = i * w / 2;
      b = (i + 1) * w / 2 − 1;
      while (a < b) {
        temp = src[a + index];
        src[a + index] = src[b + index];
        src[b + index] = temp;
        a++;
        b−−;
      }
    } //mirror u
        index = w * h / 4 * 5;//V an initial position
    for (i = 0; i < h / 2; i++) {
      a = i * w / 2;
      b = (i + 1) * w / 2 − 1;
      while (a < b) {
        temp = src[a + index];
        src[a + index] = src[b + index];
        src[b + index] = temp;
        a++;
        b−−;
        }
      } //mirror v.
```

As shown in FIG. 10 and FIG. 11, in some embodiments, when the at least one processor controls the display to split a screen into two display windows, the display is controlled to split a screen into two display windows on left and right equally. In a case of splitting the display into two display windows on left and right equally, in order to make the position of the second pop-up menu 1003 displayed in the first display window 1001 reasonable, that is, to achieve the presentation effect as shown in FIG. 11, at least one processor needs to perform following S851 to S853.

S851: Obtaining a window width of the display, a preset edge margin width, a quantity of options in the second pop-up menu 1003 and widths of the options in the second pop-up menu 1003.

The at least one processor can obtain the window width of the display from a configuration parameter in a WindowManager method in an underlying operating system, determine the preset edge margin width, the quantity of options in the second pop-up menu 1003, and the width of each option according to parameters configured in the system. The edge margin width is a width reserved on left and right around the second pop-up menu 1003 when the second pop-up menu 703 is displayed, that is, a width from a left edge or a right edge of the second pop-up menu 1003 to an edge of the first display window 1001.

S852: Determining a horizontal coordinate of a reference point of the second pop-up menu based on the window width, the edge margin width, the quantity of options in the second pop-up menu 1003, and the widths of the options in the second pop-up menu 1003, where the horizontal coordinate of the reference point is a coordinate in a global coordinate system of the display.

After obtaining the window width, the edge margin width, the quantity of options in the second pop-up menu 1003, and the widths of the options in the second pop-up menu 1003, at least one processor can then use xray=screenWidth/2+(screenWidth/4−(itemWidth*N+itemMargin*(N−1)+padding/2)/2) to obtain the horizontal coordinate of the reference point of the second pop-up menu. In the foregoing formula, screenWidth represents the window width, item Width represents a width of a single option, N represents the quantity of options in the second pop-up menu, itemMargin represents the option margin width, and padding represents the edge margin width. It should be noted that the horizontal coordinate of the reference point is a coordinate in the global coordinate system of the display.

S853: Controlling the display to display the second pop-up menu 1003 including the mirroring option at the horizontal coordinate of the reference point, to realize display of the second pop-up menu in the first display window 1001.

Aft determining the horizontal coordinate reference point, the at least one processor determines a display position of the second pop-up menu 1003 on the display according to the horizontal coordinate of the reference point and a preset vertical coordinate, and controls the display to display the second pop-up menu 1003 according to the display position, to implement presentation of the second pop-up menu 1003 as shown in FIG. 11.

As shown in FIG. 11, in some embodiment of the present disclosure, in the second pop-up menu 1003 that the at least one processor controls the display to display in the first display window 1001 in a floating mode, in addition to the mirroring option, a focus window switching option is also included. Correspondingly, the at least one processor can further perform S870 to S880 as follows.

S870: Based on that a control command triggering the focus window switching option is received, controlling the display to switch a second display window 1002 for playing the current video to a focus window, and controlling the display to display a third pop-up menu 1004 including a full screen play option in the second display window 1002.

The focus window is a window in a selected state among the first display window 1001 and the second display window 1002. In a case that the first display window 1001 or the second display window 1002 is the focus window, when the at least one processor receives a menu popup command, a pop-up menu is displayed in the focus window.

When the user wants to control the local video displayed in the first display window 1001 to be mirror flipped left and right, the control command for the focus window switching option can be sent to the at least one processor of the display apparatus through a remote control, a terminal device, or gesture control.

When the at least one processor receives the control command for the focus window switching option, the at least one processor invokes an ActivityManager method provided by the operating system to switch the second display window 1002 to the focus window, and invokes an updateViewLayout method in the WindowsManager provided by the operating system, to display a third pop-up menu 1004 in the second display window 1002 of the display.

FIG. 12 is a schematic diagram of a user interface displayed by a display in another case according to some embodiments of the present disclosure. As shown in FIG. 12, the third pop-up menu 1004 is located in the middle of a lower edge in the second display window 1002. In an implementation, in order to display the third pop-up menu 1004 in the middle of the lower edge of the second display window 1002, the at least one processor determines a horizontal coordinate a reference point of the third pop-up menu 1004 using the following method. The window width of the display, the preset margin width, a quantity of options in the third pop-up menu 1004, and widths of the options are obtained first, then xray=screenWidth/4−(Item Width*M+(M−1)*itemMargin+padding*2)/2 is used to determine the horizontal coordinate of the reference point of the third pop-up menu 1004. As before, screenWitdth represents the window width, item Width represents the width of a single option, and itemMargin represents the option margin width, padding represents the edge margin width, and M is the quantity of options in the third pop-up menu 1004.

As previously described, a full screen play option is included in the third pop-up menu 1004. When the user wants to control the display apparatus to exit the split screen display and display the current video in a full screen display mode, a control command triggering the full screen play option can be sent to at least one processor of the display apparatus through a remote control, a terminal device or gesture control. After receiving the control command triggering the full screen play option, the at least one processor controls the display to resume playing the current video in a full screen mode. In a specific implementation, when the user feels that a certain fitness action is particularly difficult to learn and wants to watch the content of the fitness video carefully first, through the full screen play option, full screen play of the current video can be quickly realized, so that the user has a better use experience.

As shown in FIG. 12, in the third pop-up menu 1004, in addition to including the full screen play option, a focus window switching option and an exit option are further included. The focus window switching option is used for triggering re-switching of a focus window currently displayed by the display to the first display window 1001, and the exit option is used for controlling exit displaying the third pop-up menu 1004.

Referring back to FIG. 11, in some embodiments of the present disclosure, the second pop-up menu 1003 includes a full screen play option in addition to the mirroring option and the focus window switching option described above. The full screen play option is used for triggering the display to display the local video in full screen. In an implementation, the display apparatus is often equipped with a speaker. When the display plays a video content of the current video, the speaker simultaneously plays an audio content corresponding to the current video, so that the user receives fitness teaching information through sound and light simultaneously. In some cases, the user can already be familiar with the fitness action through prior follow-on training. In this case, there is no need to continue watching the current action. The user only wants to complete the fitness action by himself/herself under the guidance of the audio corresponding to the current video. In this case, the user also needs to pay attention to whether his/her action is correct or not.

In order to meet the requirements, in embodiments of the present disclosure, a full screen play option is also set in the second pop-up menu 1003. When the user wants to control the full screen playing of the local video, a control command triggering the full screen play option can be sent to the at least one processor of the display apparatus through a remote control, a terminal device, or gesture control. Correspondingly, the at least one processor performs S880 as follows.

S880: Based on that a control command triggering the full screen play option is received, controlling the display to play the local video in the full screen mode, and controlling the speaker to play an audio corresponding to the current video simultaneously.

In embodiments of the present disclosure, when the full screen play option in the second pop-up menu 1003 is triggered, at least one processor controls the display to play the local video in full screen and continues to control the speaker to play the audio corresponding to the current video, so that the user can complete the fitness action by himself/herself under the guidance of the audio and pay attention to whether the action is correct or not, and the use experience is improved.

Referring to FIGS. 10-12, in some embodiments of the present disclosure, when the display displays the current video and the local video in left and right split screens, since an image size of the current video does not match a window size of the first display window 1001, an image size of the local video does not match a window size of the second display window 1002, in order to play both contents of the current video and the local video, both the current video and the local video are zoomed-out for display, there is a large blank background above and below the first display window 1001 and the second display window 1002. Since both the current video and the local video are zoomed-out, the user can need to be close to the display apparatus to more clearly see the fitness content in the current video and the local video, and the use experience is poor. Additionally, in some cases, when the user is too close to the display apparatus, some fitness actions cannot be completed due to limitation by the display apparatus.

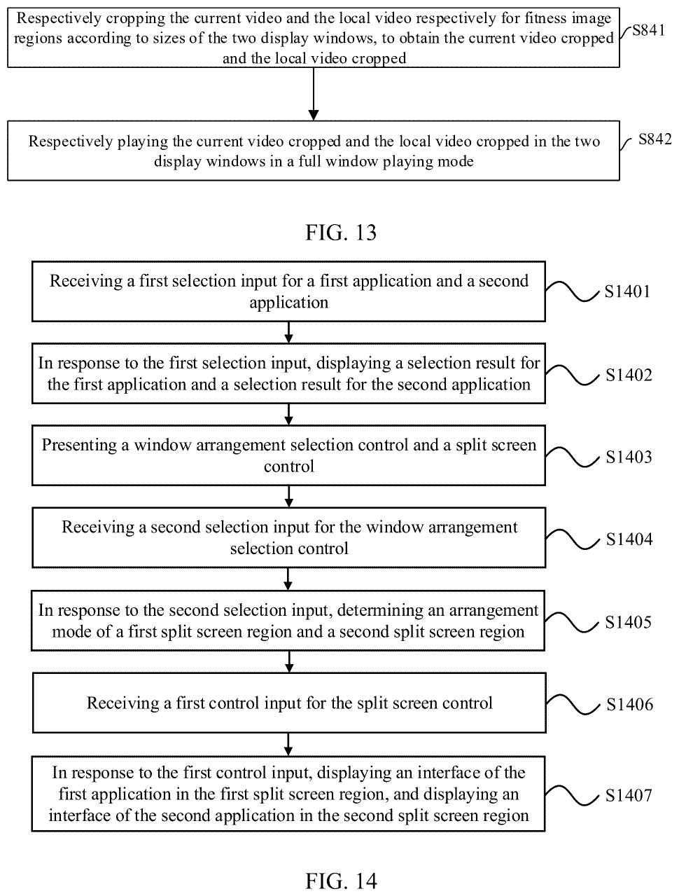

FIG. 13 is a second flowchart of a second processing method for a display apparatus according to some embodiments of the present disclosure, for controlling the two display windows to play the current video and local video. As shown in FIG. 13, in order to address the above problem and make full use of the display interface of the display apparatus, at least one processor performs S841 to S842 as follows.

S841: Respectively cropping the current video and the local video respectively for fitness image regions according to sizes of the two display windows, to obtain the current video cropped and the local video cropped.

In embodiments of the present disclosure, at least one processor can obtain a size of the first display window 1001 and a size of the second display window 1002. After obtaining the size of the first display window 1001, the at least one processor can crop the local video for a fitness image region according to the size of the first display window 1001, to obtain a fitness image region in the local video, and take a video content of the fitness image region in the local video as the local video cropped. After obtaining the size of the second display window 1002, the at least one processor can crop the current video for a fitness image region according to the size of the second display window 1002, to obtain a fitness image region in the current video.

In some embodiments, the at least one processor can employ a pre-trained body recognition model, to identify a human body position region in the current video and the local video in real time, and determine a fitness image region cropped. In some other embodiments, the at least one processor can use an image subtraction algorithm, to compare pixel content changes of adjacent frames of the current video to determine a corresponding fitness image region, and compare pixel content changes of adjacent frames of the local video to determine a corresponding fitness image region.

S842: Respectively playing the current video cropped and the local video cropped in the two display windows in a full window playing mode.

Because the fitness images of the current video and the local video are respectively cropped according to the size of the display window, to obtain the current video cropped and the local video cropped, the current video cropped and the local video cropped match with a size of a corresponding display window (match with a length-to-width ratio of the corresponding display window), the at least one processor can control to respectively play the current video cropped and the local video cropped in the two display windows in a full screen playing mode.

By performing the S841 to S842, the display apparatus can play a fitness teaching part in the current video and a user self-training part in the local video in a full screen playing mode, and that user can more clearly view the corresponding content and realize action comparison. In addition, by playing the current video cropped and the local video cropped in a full screen playing mode, a blank background in the display window can be avoided or even removed, and the viewing experience of the user is improved.

In the foregoing embodiments, when the at least one processor controls the display to perform S840 to control the display to respectively play the current video and the local video in two display windows, and receives a menu pop-up command again, the at least one processor controls the display to display a second display pop-up window in the first display window. In other embodiments, when the at least one processor controls the display to respectively play the current video and the local video in two display windows, and receives a menu pop-up command again, the at least one processor controls the display to display a third pop-up menu including a full screen play option and a focus window switching option in a second display window for playing the current video, that is, the menu shown in FIG. 12 is displayed. The third pop-up menu includes a full screen play option and a focus window switching option. Then, based on that a control command triggering the full screen play option is received, the at least one processor controls the display to resume playing the current video in a full screen mode. Based on that a control command triggering the focus window switching option is received, the at least one processor controls the display to switch a first display window for playing the local video to a focus window, and controls the display to display a second pop-up menu including a mirroring option and an exit full screen play option in the first display window. In addition to providing the method for implementing split screen display and exiting split screen display by invoking a pop-up menu, the display apparatus in embodiments of the present disclosure further provides a scheme of presetting a split screen mode, and selecting an application started in the split screen mode. After a user enters a specific interactive interface, the interactive interface displays a split screen fitness mode, and displays a client application that is available for use in the split screen fitness mode. After the user selects the client application to be used and confirms, at least one processor of the display apparatus controls the display to enter a split screen display mode, display two windows, display a playing interface of the client application selected in a display window, and display the local video photographed by the front camera in the other display window.

At present, a software system of an intelligent device supports split screen display of applications, but only applications for the split screen display can be obtained from a recently accessed application list, and a loading order of the applications in the recently accessed application list is fixed, so that an application range of the split screen display is greatly limited. A user cannot perform split screen display for an application according to his/her own will, which is not friendly to the user's interactive experience.

In view of this, as shown in FIG. 14, FIG. 14 is a flowchart of a third processing method for a display apparatus according to some embodiments of the present disclosure. The method is for split screen display and includes following steps.

S1401: Receiving a first selection input for a first application and a second application.

Various inputs described in embodiments of the present disclosure (e.g., a first selection input, a second selection input, a first control input, a second control input, etc.) can be an input for a corresponding application identifier from a user or an input for a corresponding operation control from a user. The input mode can be a click input, a voice input, or the like.

The click input can include a single click input or a double click input, the click input can be a finger click input, and can also be a click input through an input device such as a mouse, and can also be a click input sent through a remote control or other control devices, which is not limited in embodiments of the present disclosure.

The application identifier can be understood as an icon of an application or any other control that can represent an application, for example, an application identifier of the first application, an application identifier of the second application, and the like in embodiments of the present disclosure.

S1402: In response to the first selection input, displaying a selection result for the first application and a selection result for the second application.

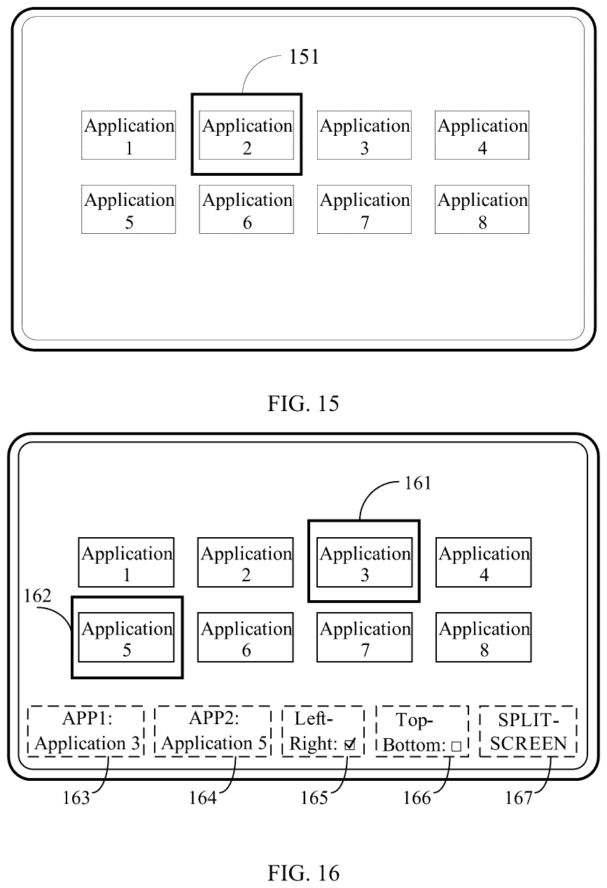

FIG. 15 is a first schematic diagram of an interface of a display apparatus according to some embodiments of the present disclosure. An application selection interface is shown in FIG. 15. The application selection interface includes application identifiers of a plurality of applications supported by a current platform and can be selected by a user, and the application identifiers respectively represent an application 1, an application 2, and so on. The application selection interface further includes a focus frame 151 for representing an application currently pre-selected by a user. For example, in the interface shown in FIG. 15, the application currently pre-selected by the user is the application 2.

FIG. 16 is a second schematic diagram of an interface of a display apparatus according to an embodiment of the present disclosure. On the basis of the application selection interface shown in FIG. 15, FIG. 16 shows a selection result for the first application and a selection result for the second application according to the first selection input from the user. As shown in FIG. 16, a first focus frame 161 and a second focus frame 162 respectively represent the selection result for the first application and the selection result for the second application from the user. The selection result for the first application and the selection result for the second application from a current user are an application 3 and an application 5, respectively.

In some embodiments, in response to the first selection input for the first application and the second application received through the user input interface, the first focus frame is moved to a position where the application identifier of the first application is located, the second focus frame is moved to a position where the application identifier of the second application is located. A color of the first focus frame and/or a color of the second focus frame are changed. The first focus frame with the changed color is used for indicating the selection result the first application for the user, and the second focus frame with the changed color is used for indicating the selection result for the second application for the user.

Split screen display requires a user to select at least two applications. The user first selects the first application through the first focus frame, and then selects the second application through the second focus frame. When a user needs to start applications for split screen, a position of the first focus frame in the display apparatus is controlled. When the first focus frame is moved to the position of the identifier of the first application required to be selected by the user, the selection result for the first application for the user is identified by changing the color of the first focus frame. Similarly, a position of the second focus frame in the display apparatus is controlled. When the second focus frame is moved to the position of the identifier of the second application required to be selected by the user, the selection result for the second application for the user is identified by changing the color of the second focus frame.

In some embodiments, the selection result for the first application or the second application for the user can also be identified by changing a shape of a focus frame, which is not limited in embodiments of the present disclosure.

In some embodiments, the application selection interface can also show the selection result for the first application for the user and the selection result for the second application for the user through a name of an application. As shown in FIG. 16, the name of the first application is displayed in a first application name presentation region 163, and the name of the second application is displayed in a second application name display region 164. It can be understood that the position and the display content of the display region of the application name according to embodiments of the present disclosure are only examples, and should not be taken as a limitation on implementations of the present disclosure.

In some embodiments, after the user selects the first application and the second application, when the first application or the second application needs to be modified, the first application or the second application can be reselected by controlling a position of a focus frame, or the first application or the second application is reselected by editing an application name in a name display region of an application.

S1403: Presenting a window arrangement selection control and a split screen control.

The window arrangement selection control is used for a user to select an arrangement mode for a first split screen region and a second split screen region. The window arrangement selection control can be implemented by a selection control, or can be implemented in a form of a pull-down menu control or in other forms of controls, which is not limited in embodiments of the present disclosure.

The split screen control is used for a user to start a split screen display function. When an operation on the split screen control from a user is received, based on the selection result for the first application and the selection result for the second application, the first application and the second application are displayed on a display apparatus in a split screen.

S1404: Receiving a second selection input for the window arrangement selection control.

S1405: In response to the second selection input, determining an arrangement mode of a first split screen region and a second split screen region.

A user can select an arrangement mode of split screen windows. In embodiments of the application, in response to the second selection input for the window arrangement selection control, a split display mode for the first application and the second application desired by the user can be determined.

The first split screen region and the second split screen region can be arranged in a left-right split screen mode. The first split screen region can be displayed on a left side of a screen, and the second split screen region can be displayed on a right side of the screen. Or, the first split screen region can be displayed on the right side of the screen, and the second split screen region can be displayed on the left side of the screen. Alternatively, the first split screen region and the second split screen region can be arranged in a top-bottom split screen mode. The first split screen region can be displayed on a top side of the screen, and the second split screen region can be displayed on a bottom side of the screen. Or, the first split screen region can be displayed on the bottom side of the screen, and the second split screen region can be displayed on the top side of the screen.

In some embodiments, as shown in FIG. 16, the application selection interface displays a left-right arrangement (Left-Right) control 165 and a top-bottom arrangement (Top-Bottom) control 166. When a second selection input for the left-right arrangement control 165 is received, it is determined that a user desires to display a first application and a second application in a split screen in a left-right arrangement mode. When a second selection input for the top-bottom arrangement control 166 is received, it is determined that the user desires to display a first application and a second application in a split screen in a top-bottom arrangement mode. The application selection interface further displays a split screen control 167 for a user to start the split screen display function.

S1406: Receiving a first control input for the split screen control.

S1407: In response to the first control input, displaying an interface of the first application in the first split screen region, and displaying an interface of the second application in the second split screen region.

Referring to the above steps, after determining the split screen mode of the first application and the second application, in response to the first control input for the split screen control, split screen display is performed based on the selection result for the first application and the selection result for the second application. The interface of the first application is displayed in the first split screen region, and the interface of the second application is displayed in the second split screen region.

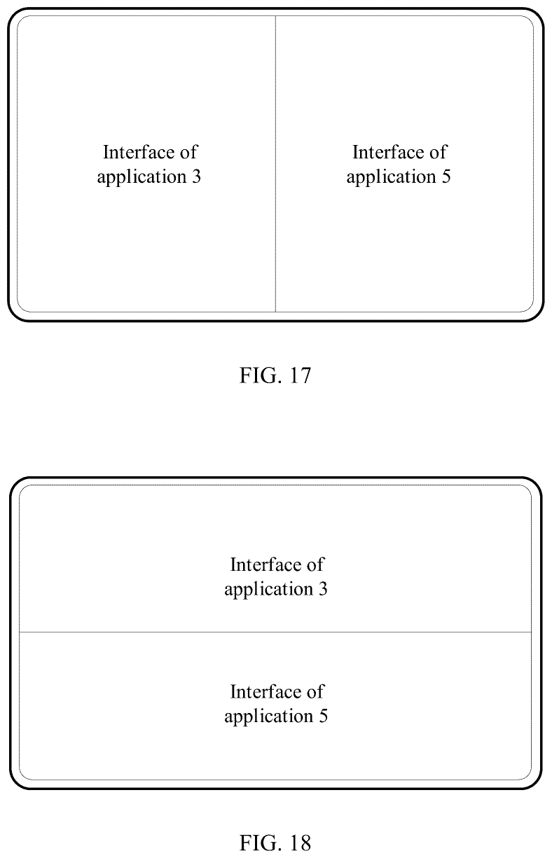

FIG. 17 is a third schematic diagram of an interface of a display apparatus according to some embodiments of the present disclosure. Referring to FIG. 16, the first application selected is an application 3, and the second application selected is an application 5. In response to the second selection input for the left-right arrangement control 165 in the interface as shown in FIG. 16 form the user, it is determined that the arrangement mode of the first split screen region and the second split screen region is left-right arrangement. In response to the first control input for the split screen control 167 in the interface as shown in FIG. 16 form the user, an application interface of the first application and an application interface of the second application are respectively displayed in the first split screen region and the second split screen region which are arranged left and right. That is, a schematic diagram of an interface of the display apparatus as shown in FIG. 17 is displayed.

FIG. 18 is a fourth schematic diagram of an interface of a display apparatus according to some embodiments of the present disclosure. Referring to FIG. 16, the first application selected is the application 3, and the second application selected is the application 5. In response to the second selection input for the top-bottom arrangement control 166 in the interface as shown in FIG. 16 from the user, it is determined that the arrangement mode of the first split screen region and the second split screen region is top and bottom. In response to the first control input for the split screen control 167 in the interface as shown in FIG. 16 from the user, the application interface of the first application and the application interface of the second application are respectively displayed in the first split screen region and the second split screen region which are arranged up and down. That is, a schematic diagram of an interface of the display apparatus as shown in FIG. 18 is displayed.

In embodiments of the present disclosure, before split screen display of applications, a user selects applications required for split screen display and a direction of split screen display for the applications, so that an application interface can be displayed in an ideal split screen display region on a screen according to the desire of the user, which provides the user with a more friendly interactive experience of split screen display.

In some embodiments, in response to a first selection input for a first application and a second application, a selection result for the first application and a selection result for the second application are displayed, and a window arrangement selection control and a split screen control are presented, then a selection order of the first application and the second application is presented based on a second selection input for the first application and the second application.

Display positions of the first split screen region and the second split screen region can be specified. For example, when the left-right split screen display mode is adopted, the first split screen region is displayed on the left interface of the display apparatus by default, and the second split screen region is displayed on the right interface of the display apparatus. When the split screen function is started, the interface of the first application is displayed on the left interface of the display apparatus, and the interface of the second application is displayed on the right interface of the display apparatus. When the selection order of the first application and the second application is exchanged, the split screen display positions of the two applications are also exchanged.

When the user selects the application 3 as the first application and the application 5 as the second application, and when the left-right split screen display mode is adopted, in this case, when the split screen function is started, the interface of the application 3 is displayed on the left interface of the display apparatus, and the interface of the application 5 is displayed on the right interface of the display apparatus. When the user selects the application 5 as the first application and the application 3 as the second application, and when the left-right split screen display mode is adopted, in this case, when the split screen function is started, the interface of the application 5 will be displayed on the left interface of the display apparatus, and the interface of the application 3 is displayed on the right side of the display apparatus.

Thus, based on the second selection input for the first application and the second application, a selection order of the first application and the second application can be presented, so that the user can know positions in interfaces of the display apparatus to display interfaces of currently selected two applications to be displayed in a split screen. At the same time, by changing the selection order of the applications for split screen display, the user can also determine positions in interfaces of the display apparatus to display interfaces of two applications to be displayed in a split screen.

As shown in FIG. 16, the name of the first application can be displayed in the first application name presentation region 163, and the name of the second application can be displayed in the second application name display region 164. That is, the name of the application previously selected by the user is displayed in the first application name display region 163, and the name of the application latterly selected by the user is displayed in the second application name display region 164. When the user selects the application 3 and the application 5 respectively in order, and then selects the left-right split screen mode, the interface of the application 3 can be displayed on the left interface of the display apparatus, and the interface of the application 5 can be displayed on the right interface of the display apparatus. When the user selects the application 5 and the application 3 respectively in order, and then selects the left-right split screen mode, the interface of the application 5 can be displayed on the left side interface of the display apparatus, and the interface of the application 3 can be displayed on the right interface of the display apparatus. When the user selects the application 3 and the application 5 respectively in order, and then selects the top-bottom split screen mode, the interface of the application 3 can be displayed on the top interface of the display apparatus, and the interface of the application 5 can be displayed on the bottom interface of the display apparatus. When the user selects the application 5 and the application 3 respectively in order, and then selects the top-bottom split screen mode, the interface of the application 5 can be displayed on the top interface of the display apparatus, and the interface of the application 3 can be displayed on the bottom interface of the display apparatus. It can be understood that the above implementation content is only an example of embodiments of the present disclosure. The specific display position of the application interface shall not be taken as a limitation of embodiments of the present disclosure.

In embodiments of the present disclosure, according to the selection order of the split screen application from the user, the user can freely control the display position of the application interface in the split screen state, operability and interactivity of the third processing method for the display apparatus are effectively improved, the user experience is improved, which is more in line with needs of the market and the user.

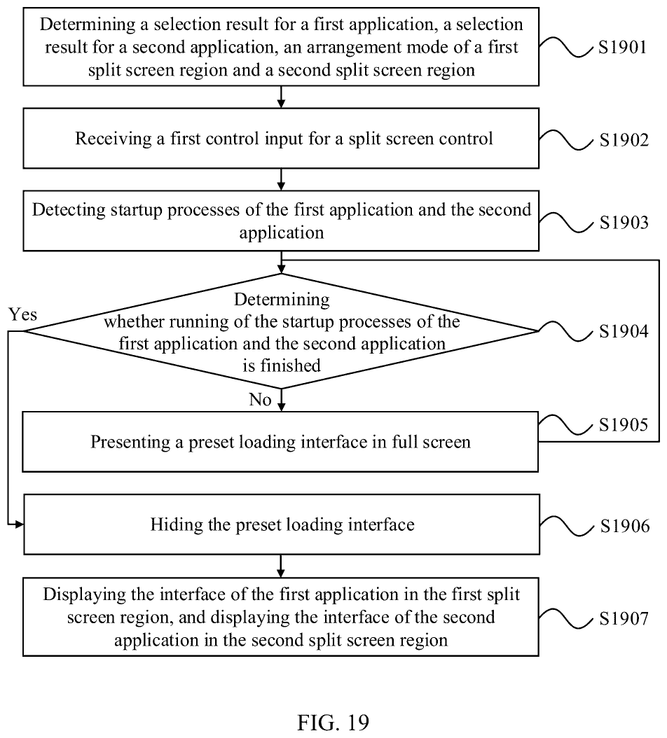

In some embodiments, as shown in FIG. 19, FIG. 19 is a second flowchart of a third processing method for a display apparatus according to some embodiments. The method is described below in conjunction with a flowchart.

S1901: Determining a selection result for a first application, a selection result for a second application, an arrangement mode of a first split screen region and a second split screen region.

S1901 can be implemented by steps from S1401 to S1405, and the implementation process and principle thereof are the same, which are not described here.

S1902: Receiving a first control input for a split screen control.

S1903: Detecting startup processes of the first application and the second application.

S1904: Determining whether running of the startup processes of the first application and the second application is finished. When the running of the startup processes of the first application and the second application is finished, S1906 is performed. When the running of the startup processes of the first application and the second application is not finished, S1905 is performed.

After the user starts the split screen display, the first application and the second application need to execute a startup process, includes loading a display interface of the first application and a display interface of the second application. When the running of the startup process of the first application is finished, it represents that the first application is successfully started and completely loaded, and the first application interface can be displayed. When the running of the startup process of the second application is finished, it represents that the second application is successfully started and completely loaded, and the second application interface can be displayed.

In particular, through the ActivityManager in the software systemManager), a process task (runningTask) of the first application and a process task (runningTask) of the second application can be obtained and detected, and whether the running of the startup processes of the first application and the second application is finished can be detected, so that it can be determined whether the first application and the second application are completely loaded.

S1905: Presenting a preset loading interface in full screen.

When the running of the startup processes of the first application and the second application is not finished, it represents that the loading of the first application or the second application is not finished. In this case, when the interface of the first application or the second application is displayed, abnormal display conditions such as interface flicker can occur. In order to avoid the above problem, when the running of the startup processes of the first application and the second application is not finished, the preset loading interface is displayed in full screen.

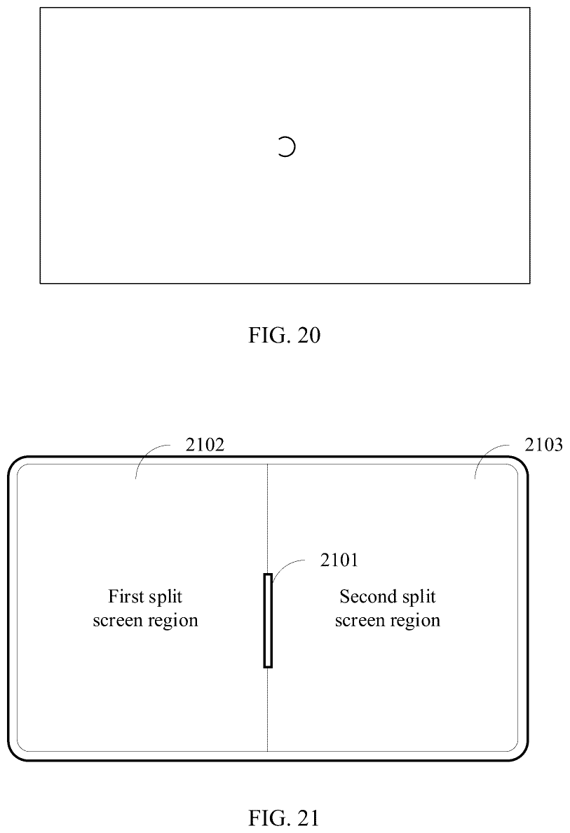

FIG. 20 is a schematic diagram of a preset loading interface according to some embodiments of the present disclosure. In FIG. 20, a rotating ring with a notch in a center of the interface indicates to a user that the display interface of the first application and the display interface of the second application is currently loading. In other possible embodiments, the preset loading interface can be any preset loading picture or loading animation, which is not limited in embodiments of the present disclosure.

S1906: Hiding the preset loading interface.

When it is detected that the running of the startup processes of the first application and the second application is finished, it represents that the first application and the second application are completely loaded. In this case, the interfaces of the first application and the second application can be displayed normally, and the preset loading interface is hidden.

S1907: Displaying the interface of the first application in the first split screen region, and displaying the interface of the second application in the second split screen region.

The selection result for the first application, the selection result for the second application, and the arrangement mode of the first split screen region and the second split screen region obtained in S1901 are passed as parameters to the Activity Manager and the Window Manager in the Application Framework layer, for the Activity Manager and the Window Manager to perform split screen display, to display the interface of the first application in the first split screen region, and display the interface of the second application in the second split screen region. For the specific display mode, please refer to the implementation mode in the above embodiment, which will not be described here.

In embodiments of the present disclosure, the preset loading interface is presented in full screen in the loading process of the first application and the second application, the abnormal display condition possibly occurring in the loading process of the split screen interface is avoided, the confusion to the user is avoided, and the user experience during the split screen display is improved.

In some embodiments, a region-controlling control can also be presented between the first split screen region and the second split screen region. In response to a second control input for the region-controlling control, sizes of the first screen region and the second split screen region are changed.

A region-controlling control can be displayed as a draggable control or as a divider. A user can change sizes of the first split screen region and the second split screen region through a second control input such as a drag on the region-controlling control. FIG. 21 is a fifth schematic diagram of an interface of a display apparatus according to some embodiments. The sizes of the first split screen region 2102 and the second split screen region 2103 can be changed by dragging a region-controlling control 2101.

Embodiments of the present disclosure can facilitate a user to adjust the sizes of the two split screen regions at will by setting the region-controlling control. Flexibility of the third processing method for the display apparatus is improved, and the interactive experience of the user is further improved.

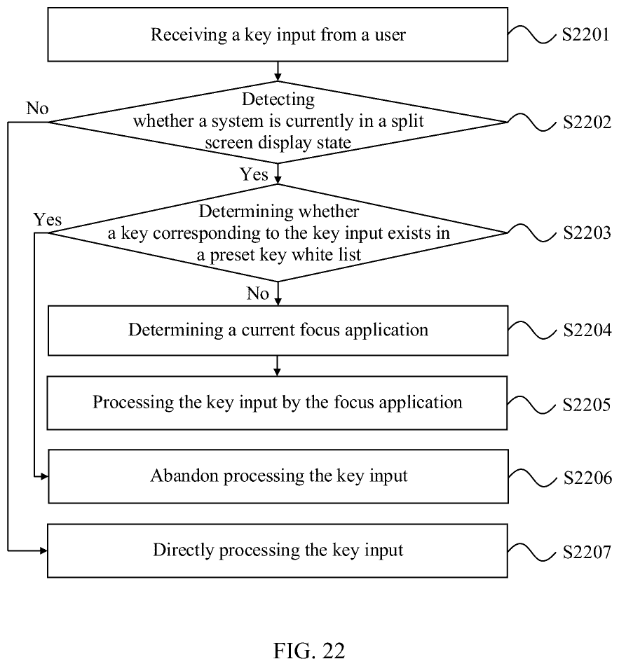

FIG. 22 is a third flowchart of a third processing method for a display apparatus according to some embodiments of the present disclosure, particularly use for key input processing. As shown in FIG. 22, the method includes following steps.

S2201: Receiving a key input from a user.

S2202: Detecting whether a system is currently in a split screen display state. When the system is currently in the split screen display state, S2203 is performed. When the system is currently not in the split screen display state, S2207 is performed.

S2203: Determining whether a key corresponding to the key input exists in a preset key white list. When the key corresponding to the key input exists in the preset key white list, S2206 is performed. When the key corresponding to the key input does not exist in the preset key white list, S2204 is performed.

The preset key white list is used for storing all keys which are not able to be responded in the split screen display state.

In the split screen state, when the key input of the user is received, in order to avoid the influence on the split screen display, it is determined whether the key corresponding to the received key input is allowed to be responded or not.

In particular, a preset key white List is added in a Phone Window Manager of the software system.

For example, the following code is added to the system:

int[ ] whitelist = {KeyEvent.KEYCODE_MENU, KeyEvent.KEYCODE_INPUT,
KeyEvent.KEYCODE_SETTINGS, KeyEvent.KEYCODE_MEDIA ,...... }.

In this way, keys recorded in the preset key white list can be set as the keys which are allowed not to be responded in the split screen display state.

S2204: determining a current focus application.

The focus application is one of the first application or the second application with a higher priority.

When the key corresponding to the key input is not recorded in the preset key white list, it is determined that the key corresponding to the currently received key input of the user needs to be responded, and it is further determined that one of the first application and the second application processes the key input.

Priorities of the first application and the second application can be preset by a user. Alternatively, the priorities of the first application and the second application can be determined according to a preset priority determination rule. For example, according to operation records on the first application and the second application from the user, it is determined that the priority of the application recently operated by the user is higher. The application with a higher priority in the first application and the second application is used as the focus application.

S2205: Processing the key input by the focus application.

The key input is sent to the focus application, and the focus application processes the key input.

S2206: Abandon processing the key input.

When the key corresponding to the key input is recorded in the preset key white list, the key input is not processed, to avoid affecting the split screen display of the current application.

S2207: Directly processing the key input.

When it is detected that the current system is not in the split screen display state, the key input in this case can not affect the split screen display of the application, the key input is directly processed according to an original rule of the system.

In embodiments of the present disclosure, the key input of a user is filtered in a split screen state by set a preset key white list, effectively preventing the key input of the user in the split screen state from affecting the split screen display state of the application, ensuring the stability of the split screen display method, and further improving the user experience.

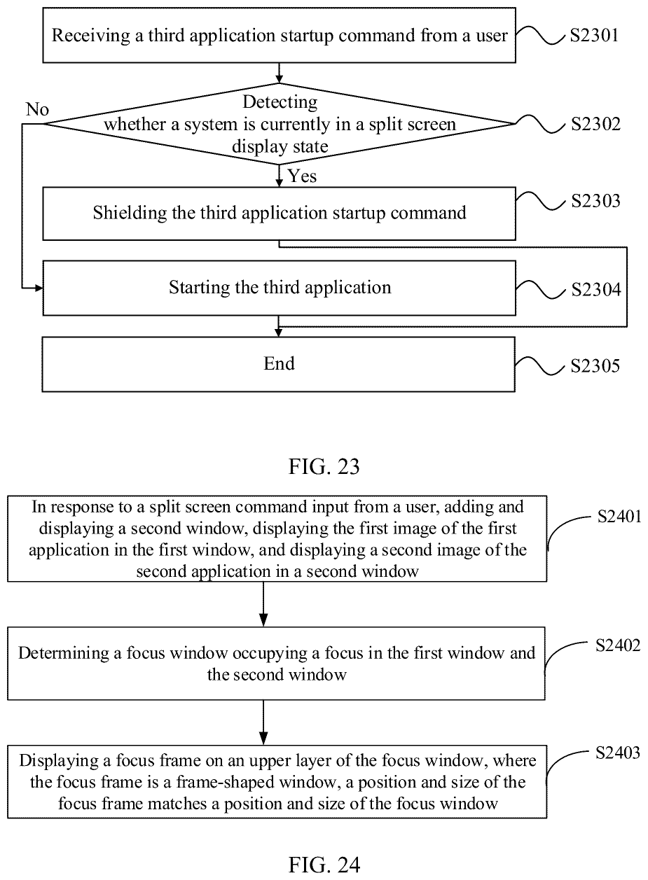

FIG. 23 is a fourth flowchart of a third processing method for a display apparatus according to an embodiment of the present disclosure. As shown in FIG. 23, the method includes following steps.

S2301: Receiving a third application startup command from a user.

A third application refers to any one of the applications other than first application and the second application displayed in a split screen. The third application startup command can be an operation command in any form such as a voice command or a gesture command. The third application startup command is used for instructing to start the third application.

S2302: Detecting whether a system is currently in a split screen display state. When the system is currently in the split screen display state, S2303 is performed. When the system is currently not in the split screen display state, S2304 is performed.

The Activity Manager in the Application Framework layer detects a current state of the system. When it is detected that the system is currently in the split screen state, the third application startup command is shielded. When it is detected that the system is currently not in the split screen state, the third application is normally operated according to the third application startup command.

S2303: Shielding the third application startup command.

When the system is currently in the split screen state, that is, the first application and the second application are currently displayed in a split screen display state, startup of the third application can cover the first application and second application currently displayed, or interrupt the current split screen state. In order to ensure the normal display of the split screen interface, the third application startup command needs to be shielded.

The third application startup command is shielded or intercepted by an Activity Manager.

S2304: Starting the third application.

When the system is currently not in the split screen state, the third application is normally started based on the third application startup command.

S2305: Ending the process.

In embodiments of the present disclosure, after the third application startup command is received, the current state of the system is firstly detected. When it is detected that the system is currently in the split screen state, the third application startup command is shielded. Abnormality of the current split screen display interface caused by the starting of the third application is avoided, stability of the third processing method for the display apparatus is further ensured, and use experience of a user is improved.

As a size of a display screen of a display apparatus 200 increases, and performance of a memory, CPU, and GPU increases, hardware performance of the display apparatus 200 can already satisfy a condition of simultaneously running a plurality of applications. Thus, the display apparatus 200 is provided with hardware conditions for configuring a split screen function. When the display apparatus 200 is configured with a split screen function, the display apparatus 200 can simultaneously display at least two windows after starting the split screen function, and display images of different applications in the at least two windows. However, a user needs to determine which one of the at least two windows occupies a focus by additional operations such as moving the focus. As a result, the user's experience is poor.

In order to address the above problem, embodiments of the present disclosure provide a fourth processing method for a display apparatus, for multi-window display, and can be applied to the display apparatus 200 as shown in FIGS. 1A-4B, or other display apparatuses. Embodiments of the present disclosure take the display apparatus 200 shown in FIGS. 1A-4B as an example, to describe the fourth processing method for the display apparatus.

When displaying a first image of a first application in a first window, a display apparatus 200 can perform multi-window display according to a flow shown in FIG. 24. Specific steps are as follows.

S2401: In response to a split screen command input from a user, adding and displaying a second window, displaying the first image of the first application in the first window, and displaying a second image of the second application in a second window.

The first application is an application currently displayed by the display apparatus 200, the first application is a split screen application, that is, the first application can run simultaneously with other split screen applications in different windows, respectively. An image of the first application is the first image.

The first window can be one or more. When there is one first window, it is indicated that the display apparatus 200 currently displays only one first application, and the first window can occupy an entire display region of the display. When there are a plurality of first windows, it is indicated that the display apparatus 200 currently displays a plurality of first applications simultaneously, the first applications are different, and are displayed in corresponding first windows respectively. The plurality of first windows respectively occupy partial display regions of the display. The partial display regions occupied by respective first windows can constitute the entire display region of the display.

The split screen command is used for instructing to display images of the first application and the second application in a split screen mode. A window for displaying the second application is the second window, and an image of the second application is the second image. The second window can be located on a left or right side of the first window, i.e., the first window and the second window are arranged horizontally. The second window can be located at an upper end or a lower end of the first window, i.e., the first window and the second window are arranged longitudinally.

The first window and the second window can be displayed according to a preset split screen ratio. For example, when the preset split screen ratio is 1:1, the first window and the second window are displayed in such a manner that display regions are equally distributed. When the preset split screen ratio is 1:2, the first window occupies one third of the display region, and the second window occupies two-thirds of the display region.

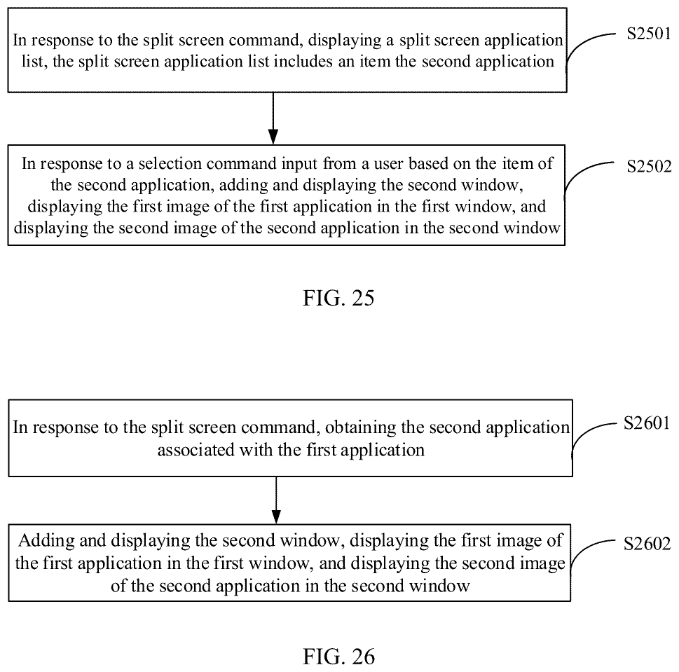

In some embodiments, the display apparatus 200 can display the first application and the second application in a split screen according to a flow shown in FIG. 25. Specific steps are as follows.

S2501: In response to the split screen command, displaying a split screen application list.

A user can input a split screen command to the display apparatus 200 based on a split screen key or the like on the control device 100. The display apparatus 200 displays the split screen application list in response to the split screen command. The split screen application list includes items of split screen applications including the second application. The split screen application in the split screen application list can be a split screen application that is installed in the display apparatus 200 and supports a split screen function. The split screen application can also be a split screen application installed in the display apparatus 200 and associated with the first application. Having an association relationship means that the first application and the split screen application are displayed on a split screen in a fixed combination.

S2502: In response to a selection command input from a user based on the item of the second application, adding and displaying the second window, displaying the first image of the first application in the first window, and displaying the second image of the second application in the second window.

When the split screen application in the split screen application list can be a split screen application installed in the display apparatus 200 that supports a split screen function, a user can select a second application that he/she wants to display on a split screen with the first application, that is, the selection command is input based on the item of the second application to instruct the display apparatus 200 to display the first application and the second application in a split screen. Therefore, the user can flexibly select the second application to be displayed in a split screen with the first application.

When the split screen application is a split screen application installed in the display apparatus 200 that has an association relationship with the first application. Generally, the split screen application is a second application, and the user can directly input a selection command based on an item of the split screen application, to instruct the display apparatus 200 to display the fixed combination in a split screen. Since the first application and the second application having the association relationship are for realizing a specific function through the split screen display, for example, the first application is a fitness video application, and the second application is a camera application, the first application and the second application are displayed on a split screen. It is possible to play the fitness video through the fitness video application, and photograph and display the action of the user through the camera application. The user can implement a specific function by displaying the first application and the second application in a split screen after selecting the second application.

In some embodiments, the display apparatus 200 can display the first application and the second application in a split screen according to a flow shown in FIG. 26. Specific steps are as follows.

S2601: In response to the split screen command, obtaining the second application associated with the first application.

The first application has a designated function, and the first application and the second application are required to realize the designated function in a split screen display mode. The split screen application that is displayed in a split screen with the first application to implement the designated function of the first application is the second application associated with the first application.

For example, the first application is a fitness video application having a designated function of a fitness action error correction function. The second application associated with the first application is a camera application. For another example, the first application is an educational application, and the designated function is a learning note function. The second application associated with the first application is a note application.

A user can input a split screen command to the display apparatus 200 based on a split screen key or the like on the control device 100. In response to the split screen command, the display apparatus 200 obtains the second application associated with the first application according to the association relationship between the first application and the second application.

S2602: Adding and displaying the second window, displaying the first image of the first application in the first window, and displaying the second image of the second application in the second window.

Displaying the first image of the first application in the first window, and displaying the second image of the second application in the second window, to implement the designated function of the first application by displaying the associated first application and second application in a split screen.

The display apparatus 200 provides a mechanism that provides access to an Android split screen application interface (Application Programming Interface, API) at a system user interface (System UI), to provide a way for an upper application to quickly enter the split screen. The Android split screen API of a window manager (WindowManager) is invoked through the System UI. A reason for choosing to provide an interface at the System UI is that: when an Android system starts, a parent process (init) will create (fork) an incubator process (Zygote), the Zygote process starts a system service (system_server) process, and the system_server process starts a boot service, a core service, and other services.

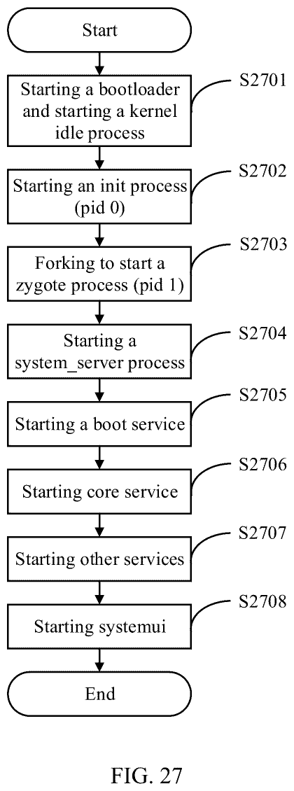

As shown in FIG. 27, an Android startup process includes following steps.

S2701: Starting a bootloader and starting a kernel idle process.

S2702: Starting an init process (pid0).

S2703: Forking to start a zygote process (pid1).

S2704: Starting a system_server process.

S2705: Starting a boot service.

S2706: Starting core service.

S2707: Starting other services.

S2708: Starting systemui.

In the Android startup process, the kernel starts the No. 0 process init, the init starts the No. 1 process zygote, the zygote process starts the system_server process. The system_server process is one of core processes of the Android system, and provides the ability of service server in Android, such as a window manager service (WindowManagerService), an activity manager service (ActivityManagerService), etc. In the main function of the system_server process, core services are started. When other services are started, the System UI process is started. The System UI is a resident process independent of the system_server process, and provides the UI of the Android system. The System UI can be regarded as an independent App, and the starting time of System UI is earlier than that of other system Apps. So adding a split screen entry within the System UI is a good option.

Prior to Android 12, the System UI's Recents class provides a way to enter a split screen, a WindowManagerProxy class provides a way to exit the split screen, and an am class provides a way to resize a window.

In the Android 12 and above, Android's native split screen control logic is located in a WindowManager directory. A split screen controller (SplitScreenController) class is available in the directory, and provides a way to enter the split screen, exit the split screen, and resize the window.

When the system_server process starts the System UI, a SystemUIService is pulled up first. An initialization (onCreate) method of the SystemUIService invokes a startServicesIfNeeded method of a SystemUIApplication. Execution of the startServicesIfNeeded method can load all System UI service classes that inherit the System UI (CoreStartable class above Android 13), and execute a start method.

In order to provide a method for quickly entering the split screen mode in the System UI for a third-party application to directly invoke the System UI, a split screen function can be injected when the System UI starts the System UI service class of the system. In order to reduce coupling, split screen logic can be injected in a vendor service (VendorServices). The VendorServices also inherits from the System UI, and is empty in the start method implemented by default. The VendorService class can instantiate a split screen manager (SplitScreenManager) class and register to monitor broadcasts. The SplitScreenManager class holds a reference to the SplitScreenController, and can invoke the method of SplitScreenController according to different types of broadcasts, to realize control operation for the split screen.

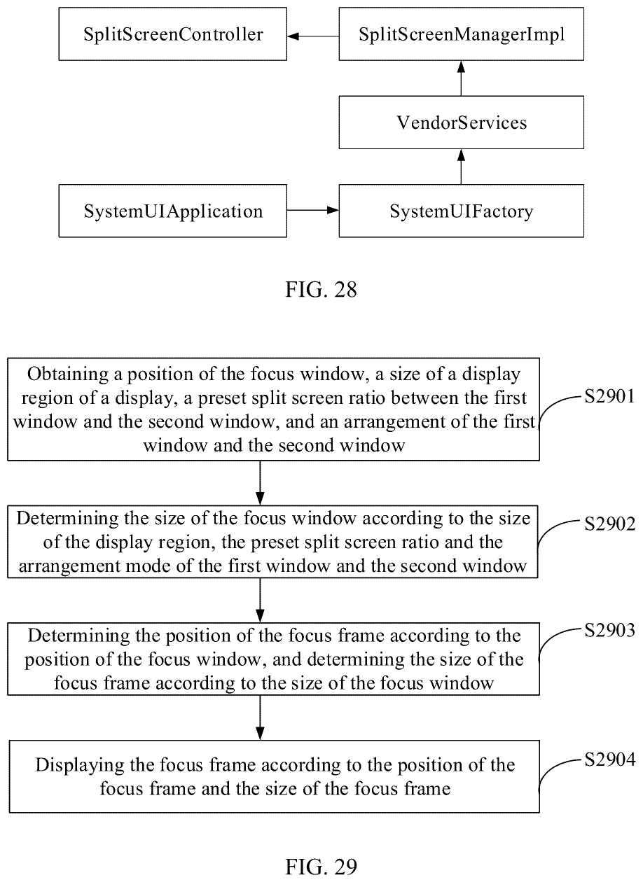

Referring to FIG. 28 for the split screen operation flow provided by the System UI. SystemUIApplication obtains SystemUI service class through SystemUIFactory. The System UIApplication invokes the start method of the VendorServices class when invoking the startServicesIfNeedeed. The VendorServices class holds a reference to a custom SplitScreenManager, and is instantiated as SplitScreenManagerImpl in the start method. SplitScreenManagerImpl can register to enter the split screen, exit the split screen, and adjust broadcast of the window through a register receiver (registReceiver) method, then invoke a system-native split screen method of SplitScreenController held by SplitScreenManagerImpl, to perform split screen operations. A shortcut entrance for split screen access is unified by providing services in the System UI. Instead of entering the split screen from the recent list, a way to send a system notification to underlying for direct invoking is provided. An original split screen logic of the system is not destroyed, facilitates management, and makes the split screen experience more harmonious, addressing the problem that the third-party application cannot directly enter the split screen.

S2402: Determining a focus window occupying a focus in the first window and the second window.

When the first window and the second window are displayed in a multi-window mode in a split screen, the window occupying the focus is the focus window. The display apparatus 200 presets a rule for occupying the focus after the split screen. For example, the leftmost window occupies the focus, the uppermost window occupies the focus, the first window occupies the focus, the second window occupies the focus, etc.

After the display apparatus 200 displays the first window and the second window in a split screen, the display apparatus 200 can determine the focus window by identifying a position where the focus is located. After the display apparatus 200 displays the first window and the second window in a split screen, the display apparatus 200 can also determine the focus window directly based on the preset rule for occupying the focus.

S2403: Displaying a focus frame on an upper layer of the focus window.

The focus frame is a frame-shaped window, that is, a middle region of the focus frame is in a hollow state. An image in the focus window below the focus frame can be displayed through the middle region. A size of the focus frame matches a size of the focus window, so that an effect that the focus frame covers and is displayed on a border of the focus window can be realized. In this way, when the focus frame is displayed on the border of the focus window, a user can see the focus frame, and an image in the focus window displayed through the focus frame. In this case, the focus frame can play a role in indicating the focus window, and the user can quickly determine the focus window according to a position of the focus frame, to quickly determine a position of the focus.

The display apparatus 200 can display the focus frame according to the flow shown in FIG. 29, and specific steps are as follows.

S2901: Obtaining a position of the focus window, a size of a display region of a display, a preset split screen ratio between the first window and the second window, and an arrangement of the first window and the second window.

The position of the focus window is a relative position of the focus window in the display region. For example, the first window and the second window are arranged left and right, and the first window is on a left side of the second window. When the focus window is the first window, the position of the focus window is the left side. When the focus window is the second window, the position of the focus window is the right side. For another example, the first window and the second window are arranged up and down, and the first window is arranged at an upper end of the second window. When the focus window is the first window, the position of the focus window is a top part. When the focus window is the second window, the position of the focus window is a bottom part.

The size of the display region can be represented by width and height. The size of the display region in a horizontal direction is width, and the size of the display region in a vertical direction is height.

The preset split screen ratio between the first window and the second window is a ratio of a size of a border of the first window to a size of a border of the second window in an arrangement direction. For example, when the first window and the second window are arranged left and right, a bottom border of the first window and a bottom border of the second window, or a top border of the first window and a top border of the second window are borders in the arrangement direction. The ratio of the size of the bottom border of the first window to the size of the bottom border of the second window is equal to the preset split screen ratio. Or, the ratio of the size of the top border of the first window to the size of the top border of the second window is equal to the preset split screen ratio. For another example, when the first window and the second window are arranged up and down, a left border of the first window and a left border of the second window, or a right border of the first window and a right border of the second window are borders in the arrangement direction. The ratio of the size of the left border of the first window to the size of the left border of the second window is equal to the preset split screen ratio. Or, the ratio of the size of the right border of the first window to the size of the right border of the second window is equal to the preset split screen ratio.

S2902: Determining the size of the focus window according to the size of the display region, the preset split screen ratio and the arrangement mode of the first window and the second window.

A size of a border of the first window and a size of a border of the second window in a non-arrangement direction are equal and equal to a size of a display region corresponding to the border. For example, when the first window and the second window are arranged left and right, a left border and a right border of the first window and a left border and a right border of the second window are borders in the non-arrangement direction. Sizes of these borders are equal to a height of the display region. For another example, when the first window and the second window are arranged up and down, a top border and a bottom border of the first window and a top border and a bottom border of the second window are borders in the non-arrangement direction. Sizes of these borders are equal to a width of the display region.

The sum of the sizes of borders of the first window and the second window in the arrangement direction is equal to the size of the display region corresponding to the borders. The ratio of the size of the border of the first window to the size of the border of the second window in the arrangement direction is equal to the preset split screen ratio. Based on the relationship, the size of the border of the first window and the size of the border of the second window in the arrangement direction can be calculated. For example, when the first window and the second window are arranged left and right, the sum of sizes of bottom borders of the first window and the second window is equal to the width of the display region. The ratio of the size of the bottom border of the first window to the size of the bottom border of the second window is equal to the preset split screen ratio, such as 2:1. The size of the bottom border of the first window is equal to two thirds of the width of the display region. The size of the bottom border of the second window is equal to one third of the width of the display region.

Based on the above process, sizes of borders of the first window and the second window can be determined, to further determine the size of each border of the focus window.

S2903: Determining the position of the focus frame according to the position of the focus window, and determining the size of the focus frame according to the size of the focus window.

The position of the focus window is the position of the focus frame in the display region, and the size of the focus window is the size of the focus frame.

S2904: Displaying the focus frame according to the position of the focus frame and the size of the focus frame.

Therefore, the focus frame can be ensured to cover and be displayed on the focus window, and the size of the focus frame matches the border of the focus window. The image displayed in the focus window will not be blocked, and the focus frame can be fully displayed.

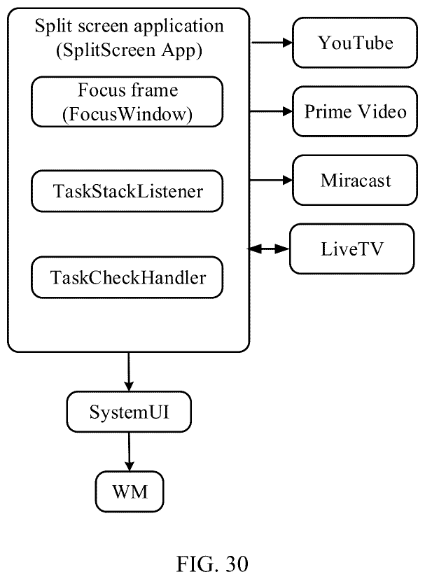

In some embodiments, the display apparatus 200 can implement the display of the focus frame based on a system architecture as shown in FIG. 30. As shown in FIG. 30, the Split Screen App can be a YouTube application, a Prime Video application, a Miracast application, or a LiveTV application. FocusWindow is a focus frame that is dynamically added to a split screen focus window, is attached above the focus window when YouTube, Prime Video and other split screen applications get the focus in the split screen state, and has the same size and position as the focus window. TaskCheckListener monitors a state change of the split screen focus window. When the size or the position of the focus window operated by a user through a remote control or a watch is changed, the FocusWindow can also update the size or position as the focus window. TaskStackListener can monitor state changes of an application stack, and respond in time to control display and hiding of FocusWindow when the split screen application stack changes.

Based on the above, the split screen mode can be quickly entered by sending broadcast to the System UI. After sending the split screen broadcast, the System UI invokes a MoveToSideStage method of the SplitScreenController to pull the split screen application into the split screen. ActivityManager provides a method to obtain a task that the system is running, encapsulates the task as running task information (RunningTaskInfo) and returns to the invoker. The RunningTaskInfo inherits from a task information (TaskInfo) class. The TaskInfo class provides a method “getWindowingMode” to obtain a window mode of a current task. The method can obtain whether the current task is in the multi-window mode. By determining whether the task of the current split screen application is in the multi-window mode, when the split screen mode is determined to be entered, a focus frame is added onto a default focus window.

Adding a focus window can use an addView method of the WindowManager, the method accepts two parameters (View view, WindowManager.LayoutParams params). The first parameter is View, which is a view to be added, that is, a focus frame itself. The second parameter is a layout parameter (LayoutParams), which is a configuration of the focus frame, such as size, position, type, window level, etc., and can be obtained through the WindowManager.

In some embodiments, LayoutParams for the focus frame can be obtained based on a coordinate system. For example, the first window and the second window are arranged left and right, the first window is located on the left side, the second window is located on the right side, and the preset split screen ratio is 1:1. A coordinate system is established using a vertex of a lower left corner of the first window as an origin, using a bottom border of the display region of the display as an x axis, and using a left border of the display region of the display as a y axis. After obtaining a width (mScreenWidth) and avheight (mScreenHeight) of the display region of the display, a width and avheight of the focus frame can be calculated, to indicate a position of the focus frame.

When the focus window is the first window, the LayoutParams of the focus window can be expressed as follows:
MLayoutParams.width=mScreenWidth/2;
MLayoutParams.height=mScreenHeight;
MLayoutParams.x=0;
MLayoutPartams.y=0.

When the focus window is the second window, the LayoutParams of the focus window can be expressed as follows:
MLayoutParams.width=mScreenWidth/2;
MLayoutParams.height=mScreenHeight;
MLayoutParams.x=mScreenWidth/2;
MLayoutPartams.y=0.

In some embodiments, after the first application and the second application are displayed on a split screen, the display apparatus 200 can replace one of the applications displayed according to the following method.

The display apparatus 200 moves a focus to a target window in response to a movement command input from a user, and displays a focus frame on an upper layer of the target window.

The application displayed in the target window is the target application that needs to be replaced.

The display apparatus 200 displays a split screen application list in the target window in response to a split screen command input from a user.

The split screen application list includes items of split screen applications that can be displayed on a split screen with a non-target application.

The display apparatus 200 exits the target application in response to a selection command input from a user based on an item of a third application in the split screen applications, and display the third application in the target window.

In this way, the user can replace any one application currently displayed in the split screen.

Steps S2401 to S2403 are described in conjunction with following examples.

A first example is as follows.

For example, the display apparatus 200 is a television, the control device 100 is a remote control, and the first application is a YouTube application.

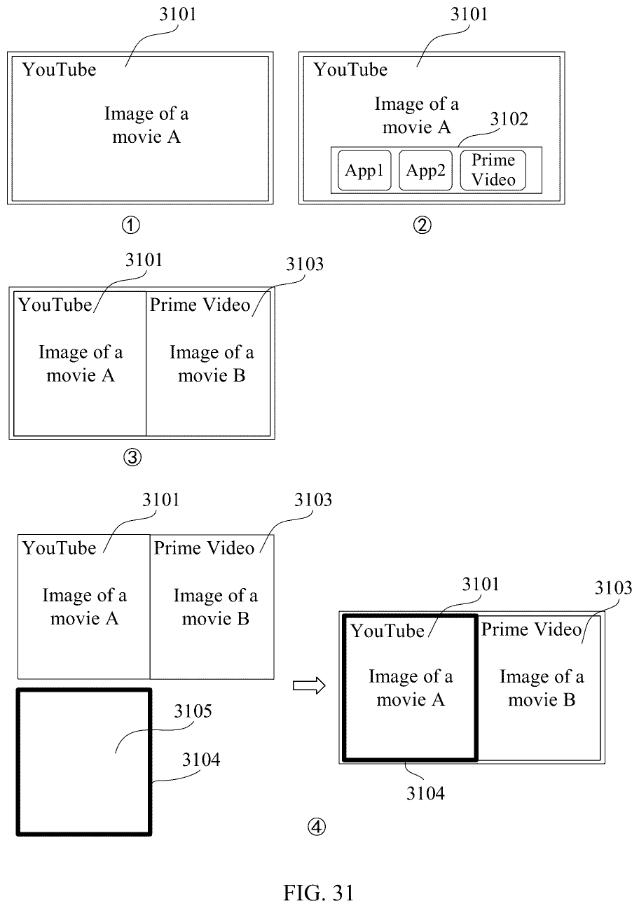

As shown in \textcircled{1} in FIG. 31, a television displays a first image of a YouTube application in a first window 3101, and the first image is an image of a movie A. A user inputs a split screen command to the television through a split screen key on a remote control. In response to the split screen command, the television displays a split screen application list 3102 on the image of the movie A, as shown in \textcircled{2} in FIG. 31. The split screen application list 3102 includes items of split screen applications that can be displayed on a split screen with the first application, such as App1, App2, and Prime Video applications. For example, when the second application is a Prime Video application, a user inputs a selection command based on an item of the Prime Video application. In response to the selection command, the television adds and displays a second window 3103 on a right side of the first window 3101, as shown in \textcircled{3} in FIG. 31, and displays a second image of the Prime Video application in the second window 3103. The second image is an image of a movie B. In this way, an effect of split screen display of the YouTube application and the Prime Video application is achieved. When the television determines that the first window 3101 is the focus window, as shown in \textcircled{4} in FIG. 31, a focus frame 3104 is added and displayed on an upper layer of the first window 3101. The focus frame 3104 is a frame-shaped window, and a region 3105 is in a hollow state. A display level of the focus frame 3104 is higher than a display level of the first window 3101. A size of the focus frame 3104 matches a size of the first window 3101. When the focus frame 3104 is displayed on the first window 3101, a border of the first window 3101 is covered by the focus frame 3104, and the image of the movie A displayed in the first window 3101 can be presented to a user through the region 3105. The user can quickly determine the focus window as the first window 3101 according to the focus frame 3104 based on a split screen interface shown in \textcircled{4} in FIG. 31.

A second example is as follows.

For example, the display apparatus 200 is a television, the control device 100 is a remote control, and the first application is a fitness application.

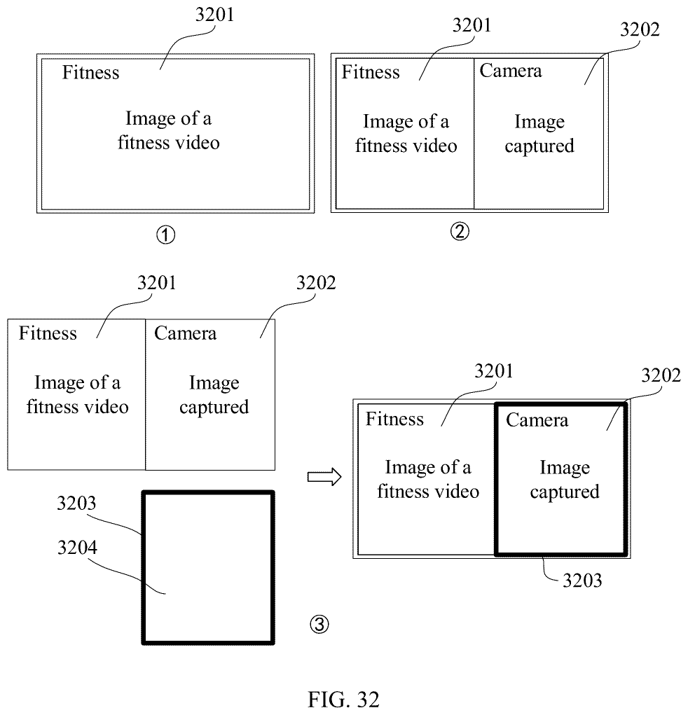

As shown in \textcircled{1} in FIG. 32, the television displays a first image of the fitness application in a first window 3201. The first image is an image of a fitness video. A user inputs a split screen command to the television through a split screen key on a remote control. In response to the split screen command, the television determines that a second application associated with the fitness application is a camera application. As shown in \textcircled{2} in FIG. 32, the television adds and displays a second window 3202 on a right side of the first window 3201. After the camera is turned on, a second image of the camera application is displayed in the second window 3202. The second screen is an image captured by a camera of the television. In this way, through split screen display of the fitness application and the camera application, an effect of correcting an action of a user during fitness of the user is realized. When the television determines that the second window 3202 is the focus window, as shown in \textcircled{3} in FIG. 32, a focus frame 3203 is added and displayed on an upper layer of the second window 3202. The focus frame 3203 is a frame-shaped window, and a region 3204 is in a hollow state. A display level of the focus frame 3203 is higher than a display level of the second window 3202. A size of the focus frame 3203 matches a size of the second window 3202. When the focus frame 3203 is displayed on the second window 3202, a border of the second window 3202 is covered by the focus frame 3203, and the image captured by the camera of the television displayed in the second window 3202 can be presented to a user through the region 3204. The user can quickly determine the focus window as the second window 3202 according to the focus frame 3203 based on a split screen interface shown in \textcircled{3} in FIG. 32.

A third example is as follows.

For example, the display apparatus 200 is a television, the control device 100 is a remote control, and the first application is a YouTube application.

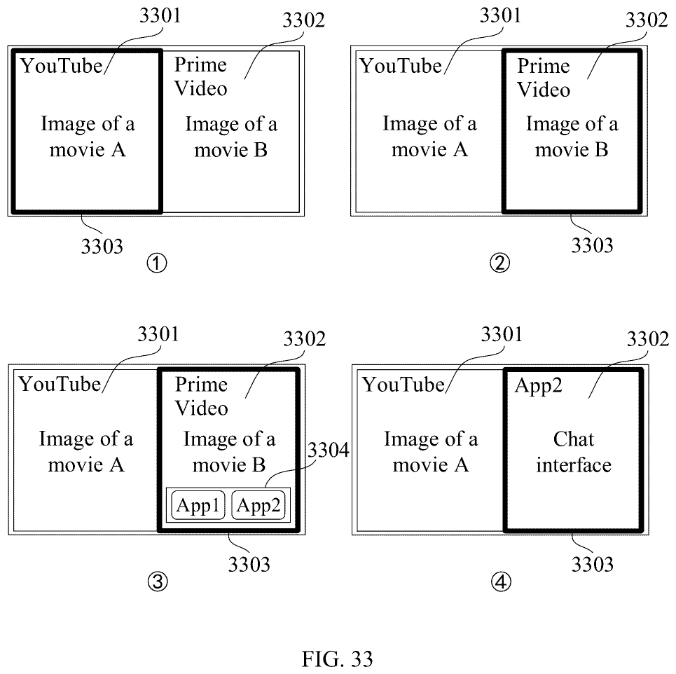

When using the YouTube application, a user can send a split screen command to the television through a split screen key on the remote control. In response to the split screen command, the television displays a split screen application list. The split screen application list includes items of applications that can be displayed on a split screen with the YouTube application, such as a Prime video application. When the user selects an item of the Prime Video application, as shown in \textcircled{1} in FIG. 33, the television displays a first image (e.g., a movie A) of the YouTube application in a first window 3301, and displays a second image (e.g., a movie B) of the Prime Video application in a second window 3302. In addition, when the television determines that the first window 3301 is a focus window, a focus frame 3303 is displayed on an upper layer of the first window 3301. The above process of displaying the YouTube application and the Prime Video application on a split screen is similar to that in the first example, and will not be repeated here.

When the YouTube application and the Prime Video application are displayed on a split screen, when a user wants to replace an application displayed on a split screen, a focus can be moved by the remote control to a window where the application needs to be replaced. For example, when the user wants to replace the Prime Video application, the focus needs to be moved to the second window 3302 through the remote control. In this case, as shown in \textcircled{2} in FIG. 33, a focus frame 3303 is updated to be displayed on the second window 3302, to indicate that the second window 3302 is the focus window occupying the focus. When the focus is displayed in the second window 3302, a user can send the split screen command to the television again through the split screen key on the remote control. In response to the split screen command, the television displays a split screen application list 3304 in the second window 3302, as shown in \textcircled{3} in FIG. 33. The split screen application list 3304 includes items of split screen applications that can be displayed with the YouTube application on a split screen. In order to prevent the user from making an invalid selection, the split screen application list 3304 does not include an option for the currently displayed Prime Video application, and includes items for other split screen applications, such as App1 and App2. The focus can be displayed by default on the first item in the split screen application list 3304. The user can control the focus to move on each item through direction keys on the remote control. When the user wants to display the App2 application with the YouTube application on a split screen, the user can press a right key on the remote control, as shown in \textcircled{3} in FIG. 33, to move the focus (shown as a bold frame) to an item of the App2 application, and press a confirmation key on the remote control to send a confirmation command to the television. In response to the confirmation command, the television can exit the Prime Video application, and as shown in \textcircled{4} in FIG. 33, display an image of the App2 application, such as a chat interface, in the second window 3302. In this case, the focus frame 3303 is still displayed on the upper layer of the second window 3302 to indicate to the user that the focus window is the second window 3302.

A fourth example is as follows.

For example, the display apparatus 200 is a television, the control device 100 is a remote control, and the first application is a fitness application.

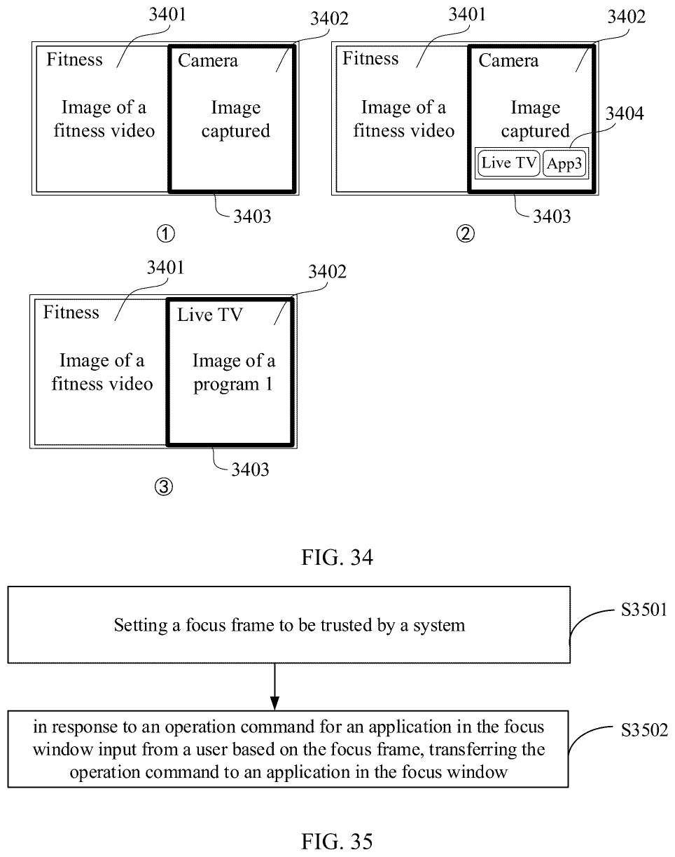

When using the fitness application, a user can send a split screen command to the television through a split screen key on the remote control. In response to the split screen command, the television can determine a camera application associated with the fitness application, and as shown in \textcircled{1} in FIG. 34, display a first image (e.g., an image of a fitness video) of the fitness application in a first window 3401, and display a second image (e.g., a captured image) of the camera application in the second window 3402. In addition, when the television determines that the second window 3402 is the focus window, a focus frame 3403 is added and displayed on an upper layer of the second window 3402. The process of displaying the fitness application and the camera application in a split screen is similar to that in the second example, which is not repeated here.

When the fitness application and the camera application are displayed on a split screen, when a user wants to replace an application displayed with the fitness application on a split screen, a focus can be moved to the second window 3402 through the remote control. In this example, since the focus is already displayed in the second window 3402, the user does not need to additionally perform the operation of moving the focus to the second window 3402. When the focus is displayed in the second window 3402, the user can send the split screen command to the television again through the split screen key on the remote control. In response to the split screen command, as shown in \textcircled{2} in FIG. 34, the television displays a split screen application list 3404 in the second window 3402. The split screen application list 3404 includes items of split screen applications that can be displayed on a split screen with the fitness application, as well as items of programs of different signal sources corresponding to fitness applications, such as live TV and App3 applications. The focus can be displayed by default on the first item in the split screen application list 3404. The user can control the focus to move on each item through direction keys on the remote control. When the user wants to display the live TV on a split screen with the fitness application, as shown in \textcircled{2} in FIG. 34, since the focus (shown as a bold frame) is displayed on the item of the live TV by default, the user can send a confirmation command to the television through a confirmation key on the remote control. In response to the confirmation command, the television can exit the camera application, and display an image of the live TV (e.g., a program 1) in the second window 3402, as shown in \textcircled{3} in FIG. 34. In this case, the focus frame 3403 is still displayed on the upper layer of the second window 3402 to indicate to the user that the focus window is the second window 3402.

In order to strengthen security of App and system platform, untrusted touch events have been added. When a window of touch is not the same App as the underlying App, the touch event can be prevented from being passed down. Therefore, when a user operates an application in the focus window under the focus frame through the touch and a mouse, the application does not respond, that is, the user can operate the application in the focus window under the focus frame through the remote control, but cannot operate through the mouse, and the a of peripheral failure occurs.

The display apparatus 200 can respond to a mouse operation according to the flow shown in FIG. 35, and the specific steps are as follows.

S3501: Setting a focus frame to be trusted by a system.

In order to make the focus frame not affect the mouse operation, the system needs to trust the window where the focus frame is located. Because the focus frame and the application in the lower focus window do not belong to the same application, attributes of the focus frame need to be modified. By analyzing and experimenting with restrictions of Android 12 on untrusted touch events, a set of reflection mechanisms to invoke a setTrustedOverlay method of WindowManager. LayoutParams are designed to circumvent this limitation of the focus window. The following code can be referred to:

```
  private void setTrustedOverlay(WindowManager.LayoutParams
  layoutParams){
  try{
    int trustedOverlayFlag=0×20000000;
    Field field=layoutParams.getClass( ).getField(name:“privateFlags”);
    field.setAccessible(true);
    field.set(layoutParams,trustedOverlayFlag);
  }Catch(NoSuchFieldException | IllegalAccessException e){
    LogUtil.d(TAG,content:“set Trusted overlay failed”+e.toString( )).
}
```

S3502: in response to an operation command for an application in the focus window input from a user based on the focus frame, transferring the operation command to an application in the focus window.

With the above settings, when adding the focus frame and initializing LayoutParams, trustedOverLay is set by directly setting privateFlags to make the system trust the added focus frame, release the touch event and pass the touch event down, to address the problem that the application in the focus window cannot respond to the mouse operation.

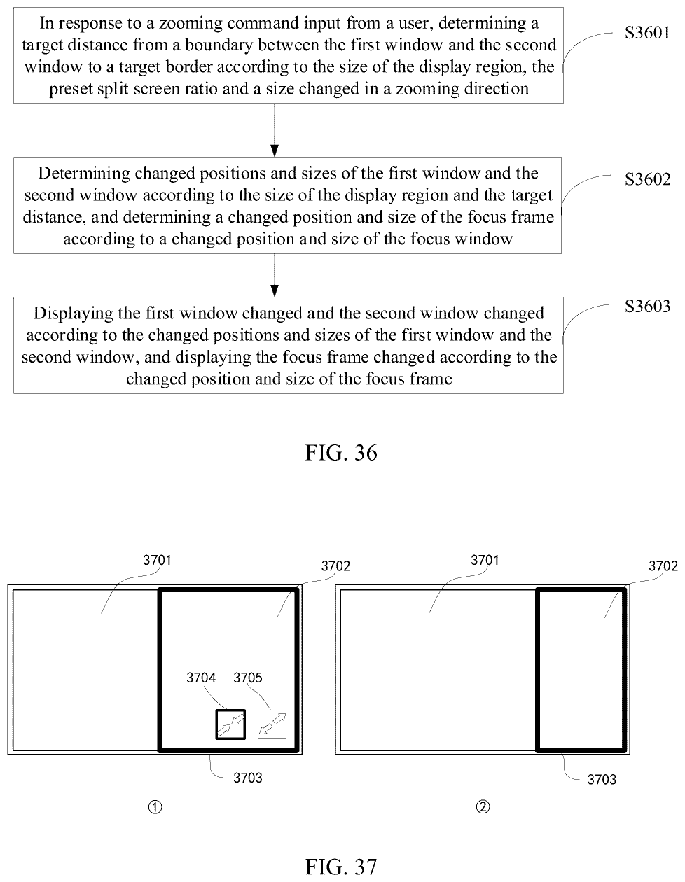

The user can zoom the focus window. The display apparatus 200 can zoom the focus window as shown in FIG. 36. Specific steps are as follows.

S3601: In response to a zooming command input from a user, determining a target distance from a boundary between the first window and the second window to a target border according to the size of the display region, the preset split screen ratio and a size changed in a zooming direction.

When the first window and the second window are arranged left and right, the zooming direction is horizontal. When the first window and the second window are arranged up and down, the zooming direction is vertical.

The target border is a first border perpendicular to the zooming direction in the display region. For example, when the first window and the second window are arranged left and right, the target border is a left border of the display region. When the first window and the second window are arranged up and down, the target border is a top border of the display region.

There is a threshold for the size of the change in the zooming direction. The threshold is a distance between the boundary of the first window and the second window and the border of the display region perpendicular to the zooming direction in the zooming direction. For example, when the zooming direction is horizontally to right, the threshold is the distance between the boundary of the first window and the second window and a right border of the display region.

S3602: Determining changed positions and sizes of the first window and the second window according to the size of the display region and the target distance, and determining a changed position and size of the focus frame according to a changed position and size of the focus window.

For example, when the first window and the second window are arranged left and right, the first window is located on the left side and the second window is located on the right side. The second window is a focus window. A current position of the focus window is located in a region starting from a target distance from a left border of the display region. A width of the first window is equal to the target distance, and a height of the first window is equal to a height of the display region. A width of the second window is equal to a difference between a width of the display region and the target distance, and a height of the second window is equal to the height of the display region.

Based on the changed positions and sizes of the first window and the second window, the changed position and size of the focus window can be determined. The changed position and size of the focus window can be directly used as the changed position and size of the focus frame.

S3603: Displaying the first window changed and the second window changed according to the changed positions and sizes of the first window and the second window, and displaying the focus frame changed according to the changed position and size of the focus frame.

The display apparatus 200 displays the first window changed and the second window changed according to the changed positions and sizes of the first window and the second window, and displays the focus frame changed according to the changed position and size of the focus frame. In this case, the focus frame changed can still be accurately displayed on the upper layer of the focus window changed, and a size of the focus frame changed matches a size of the focus window changed. In this way, an effect that the focus window is zoomed based on a zooming key in the focus window and the focus frame is dynamically adjusted based on zooming change of the focus window can be realized.

As shown in \textcircled{1} in FIG. 37, the display apparatus 200 displays a first window 3701 and a second window 3702 in a split screen. The second window 3702 is a focus window, and a focus frame 3703 is displayed on the second window 3702. A user can input a menu command to the display apparatus 200 through a menu key in the control device 100. In response to the menu command, the display apparatus 200 displays a control menu in the focus window (i.e., the second window 3702). As shown in \textcircled{1} in FIG. 37, the control menu includes a zoom-out key 3704 and a zoom-in key 3705. The user can input a zoom-out command to the display apparatus 200 based on the zoom-out key 3704. In response to the zoom-out command, the display apparatus 200, as shown in \textcircled{2} in FIG. 37, zooms out the second window 3702 and zooms in the first window 3701. The first window 3701 and the second window 3702 vary in size in a horizontal direction. Accordingly, based on the changed position and size of the second window 3702, the size of the focus frame 3703 is zoomed out accordingly, and a zooming out direction is horizontally to right. The size of the focus frame after zooming out matches the size of the second window 3702 after zooming out. The focus frame 3703 after zooming out is still displayed on the second window 3702 after zooming out.

A user can input a zoom-in command to the display apparatus 200 based on the zoom-in key 3705. In response to the zoom-in command, the display apparatus 200 zooms in the second window 3702 and zooms out the first window 3701. The first window 3701 and the second window 3702 vary in size in the horizontal direction. Accordingly, based on the changed position and size of the second window 3702, the size of the focus frame 3703 is zoomed in accordingly, and a zooming in direction is horizontally to left. The size of the focus frame after zooming in matches the size of the second window 3702 after zooming in. The focus frame 3703 after zooming in is still displayed on the second window 3702 after zooming in.

In some embodiments, updated LayoutParams of the focus frame can be obtained based on a coordinate system. For example, the first window and the second window are arranged left and right, the first window is located on a left side, and the second window is located on a right side. A coordinate system is established using a vertex of a lower left corner of the first window as an origin, using a bottom border of the display region of the display as an x axis, and using a left border of the display region of the display as a y axis. When the preset split screen ratio is 1:1, a boundary between the first window and the second window is a position of a center line of the display region. Assuming that a threshold in a zooming direction is x, when a user inputs a zoom-in command, a horizontal coordinate (a target distance) of the boundary is calculated as Mx=MscreenWidth/2+x. When the user inputs a zoom-out command, the horizontal coordinate (target distance) of the boundary is calculated as Mx=MscreenWidth/2−x. After Mx is calculated, a split screen application can notify the System UI to invoke a ChangeBound method of a system SplitScreenController to change horizontal coordinates of the first window and the second window, to display the first window and the second window after zooming.

When the split screen application notifies the System UI to invoke the changeBound method to change sizes of the first window and the second window, the horizontal coordinate parameter Mx of the boundary is passed, so the application can update the focus frame of the application itself through this parameter. Assuming that the user inputs a zoom-out command and the focus window is the second window on the right side, parameters of the focus frame updated are as follows:
MLayoutParams.width=mScreenWidth−Mx;
MLayoutParams.height=mScreenHeight;
MLayoutParams.x=Mx;
MLayoutPartams.y=0.

An updateViewLayout method of the WindowManager can be used to update the size of the focus frame, that is, WindowManager.updateViewLayout(focusWindow, MLayoutParams).

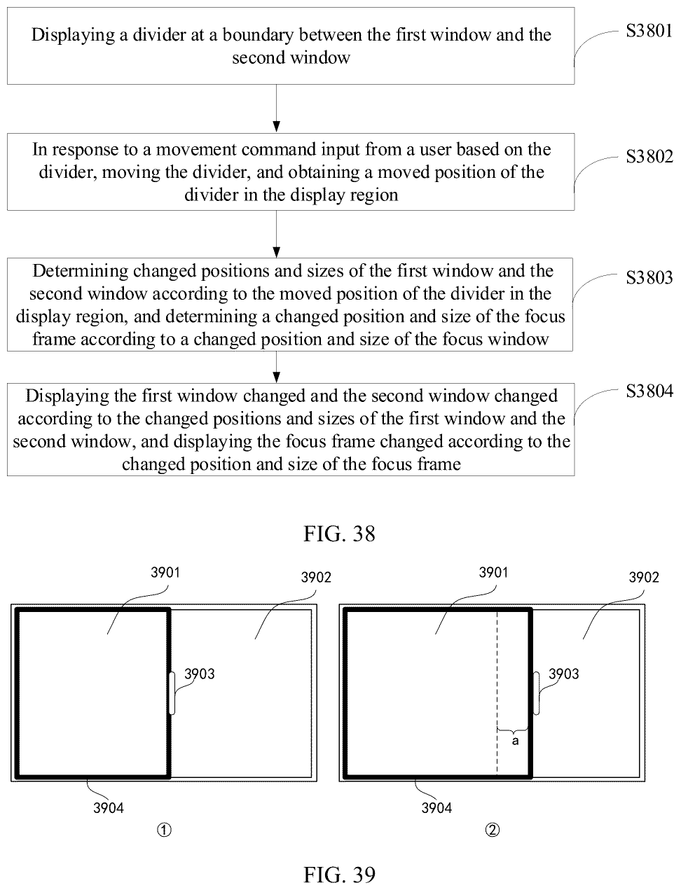

The display apparatus 200 can zoom the focus window according to the flow shown in FIG. 38, and the specific steps are as follows.

S3801: Displaying a divider at a boundary between the first window and the second window.

The Android system can automatically add a DividerView (i.e., a divider) at the boundary between the first window and the second window after the split screen. The divider can be linear, segmented, dotted, arrow-shaped, etc. The divider is used for indicating the boundary between the first window and the second window.

As shown in \textcircled{1} in FIG. 39, a divider 3903 is displayed at the boundary between the first window 3901 and the second window 3902. The divider 3903 has a segment shape. When the first window 3901 is the focus window, a focus frame 3904 is also displayed on the first window 3901.

S3802: In response to a movement command input from a user based on the divider, moving the divider, and obtaining a moved position of the divider in the display region.

The user can move the divider left and right through a mouse operation. For example, after selecting the divider through the mouse operation, the user slides the mouse to the right to input a movement command to the display apparatus 200. The movement command instructs to move the divider to the right.

In response to the movement command, the display apparatus 200 displays a movement trajectory of the divider, and obtains a moved position in the display region when the divider reaches the moved position indicated by the user.

S3803: Determining changed positions and sizes of the first window and the second window according to the moved position of the divider in the display region, and determining a changed position and size of the focus frame according to a changed position and size of the focus window.

The divider is used for indicating a boundary between the first window and the second window. Therefore, the moved position of the divider in the display region is the position of the boundary between the first window and the second window in the display region after the change. Therefore, the display region can be re-divided based on the moved position of the divider in the display region. Re-divided display regions respectively correspond to the first window changed and the second window changed. A process of determining the changed positions and sizes of the first window and the second window based on the moved position of the divider in the display region corresponds to a process of determining the changed positions and sizes of the first window and the second window based on the changed boundary between the first window and the second window.

In some embodiments, the target distance between the changed boundary between the first window and the second window and the target border can be calculated first. The target border is the first border in the display region that is perpendicular to a movement direction of the divider. Then the changed positions and sizes of the first window and the second window are determined according to the target distance and the size of the display region. The above process can refer to steps S3601 to S3602, which are not described here.

Based on the changed positions and sizes of the first window and the second window, the changed position and size of the focus window can be determined. The changed position and size of the focus window can be directly used as the changed position and size of the focus frame.

S3804: Displaying the first window changed and the second window changed according to the changed positions and sizes of the first window and the second window, and displaying the focus frame changed according to the changed position and size of the focus frame.

The display apparatus 200 displays the first window changed and the second window changed according to the changed positions and sizes of the first window and the second window, and displays the focus frame changed according to the changed position and size of the focus frame. In this case, the focus frame changed can still be accurately displayed on the upper layer of the focus window changed, and a size of the focus frame changed matches with a size of the focus window changed. In this way, an effect that the focus window is zoomed based on the divider and the focus frame is dynamically adjusted based on zooming change of the focus window can be realized.

As an example, a user controls movement of the divider 3903 through a mouse. When it is desired to enlarge the first window 3901, the movement command input from the user is a command to move the divider 3903 to the right. As shown in \textcircled{2} in FIG. 39, after the divider 3903 is moved by a distance a, the first window 3901 and the second window 3902 are adjusted based on the moved divider 3903. The first window 3901 corresponds to expanding a to the right in the horizontal direction, and the second window 3902 corresponds to shrinking a to the right in the horizontal direction. The focus frame 3904 is changed according to the changed position and size of the first window 3901, as shown in \textcircled{2} in FIG. 39. The focus frame 3904 changed is still displayed on the first window 3901 changed, and the size of the focus frame 3904 changed matches the size of the first window 3901 changed.

In embodiments of the present disclosure, a touch-monitoring callback (onTouch) method can be overridden by DividerView. When a user slides the Divider View through the mouse, the callback method can be triggered. When sliding is monitored, DividerView calculates a sliding distance:

final int position=mSplitLayout.getDividePosition( )+touchPos−mStartPos.

The DividerView then notifies the system to update sizes of the first window and the second window using a WindowContainerTransaction method.

In the onTouch callback method of Divider View, after a touch event is identified as a movement event MotionEvent.ACTION_MOVE, the sliding distance is calculated, then a notification is sent to the split screen application, and the sliding distance calculated is passed.

After the split screen application obtains the calculated value, WindowManager is also used to directly update the size of the focus frame.

After the first window and the second window are displayed in a split screen, a user can move a focus from a current focus window to other windows through clicking an application key, voice, an external device, etc., that is, the focus window is switched to operate an application in the focus window switched. The display apparatus 200 can add and display a focus frame for a window actually occupying the focus in time by detecting an application stack at regular intervals.

The display apparatus 200 creates a flow of detecting an application stack at regular intervals after displaying the first window and the second window in a split screen. The application stack corresponds to the first application and the second application that are currently displayed in a split screen. The display apparatus 200 can manage each application stack in a form of an application stack list. The first application stack is an application stack corresponding to the application actually occupying the focus, that is, the application stack corresponding to the application in the actual focus window.

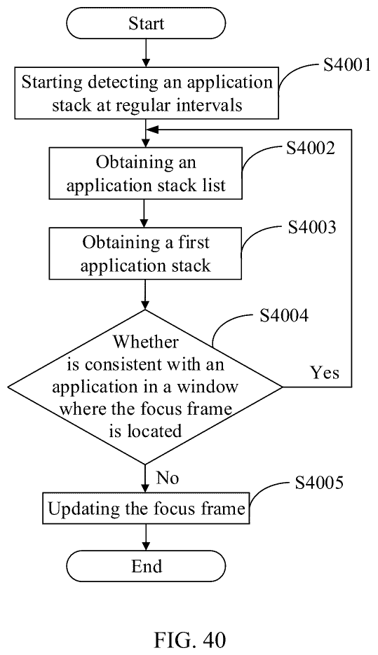

The display apparatus 200 can detect an application stack at regular intervals according to the flow shown in FIG. 40. The display apparatus 200 can control a period of detecting the application stack at regular intervals through a timer. As shown in FIG. 40, the display apparatus 200 performs following steps.

S4001: Starting detecting an application stack at regular intervals.

After detecting the application stack at regular intervals is started, the application stack is detected according to a preset period. During a detecting process, the display apparatus 200 performs step S4002.

S4002: Obtaining an application stack list.

S4003: Obtaining a first application stack in the application stack list. The first application stack indicates an application actually occupying the focus currently, i.e., an application in a focus window to be displayed with a focus frame.

S4004: Determining whether the application indicated by the first application stack is consistent with an application in a window where the focus frame is currently located. When the application indicated by the first application stack is consistent with the application in the window where the focus frame is currently located, it is indicated that the window where the focus frame is located is used for displaying the application indicated by the first application stack, and step S4002 is performed again. When the application indicated by the first application stack is not consistent with the application in the window where the focus frame is currently located, it is indicated that the window where the focus frame is located is not used for displaying the application indicated by the first application stack. That is, the focus frame is not displayed on the window where the application indicated by the first application stack is located, the display position of the focus frame is wrong, and step S4005 is performed.

S4005: Updating the focus frame.

The focus frame is updated and displayed on the window where the application indicated by the first application stack is located.

Based on the above process, it can be ensured that the display apparatus 200 updates and displays the focus frame on the window where the application actually occupying the focus is located, to accurately indicate the focus window to the user.

This process of updating and displaying the focus frame can be implemented by the TaskCheckListener in the system architecture diagram shown in FIG. 30. The ActivityManager provides a getRunningTasks method. The getRunningTasks method receives a non-argument of a maximum value of an integer, and returns a RunningTaskInfo list representing a list of running tasks. The first item in the list is the application that occupies the focus. The TaskCheckListener detects comparison between an application of the current first item and an application at a position of the current focus frame by starting a timing task, to determine whether to update a position of the focus frame.

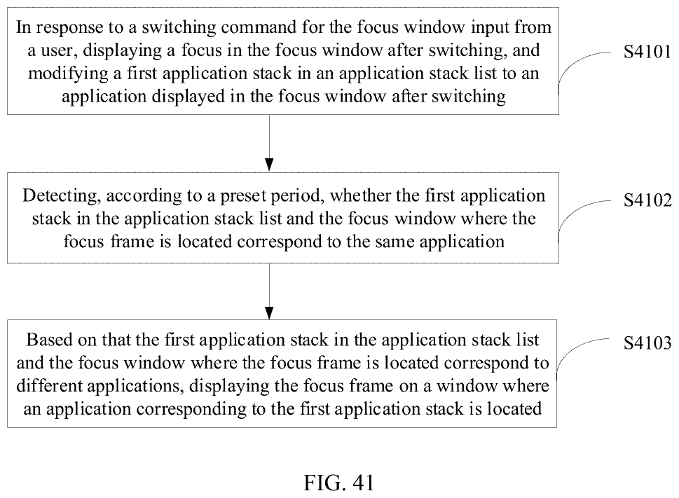

Based on the flow shown in FIG. 40, when a user switches a focus window, the display apparatus 200 can switch the focus window according to the flow shown in FIG. 41, and the specific steps are as follows.

S4101: In response to a switching command for the focus window input from a user, displaying a focus in the focus window after switching, and modifying a first application stack in an application stack list to an application displayed in the focus window after switching.

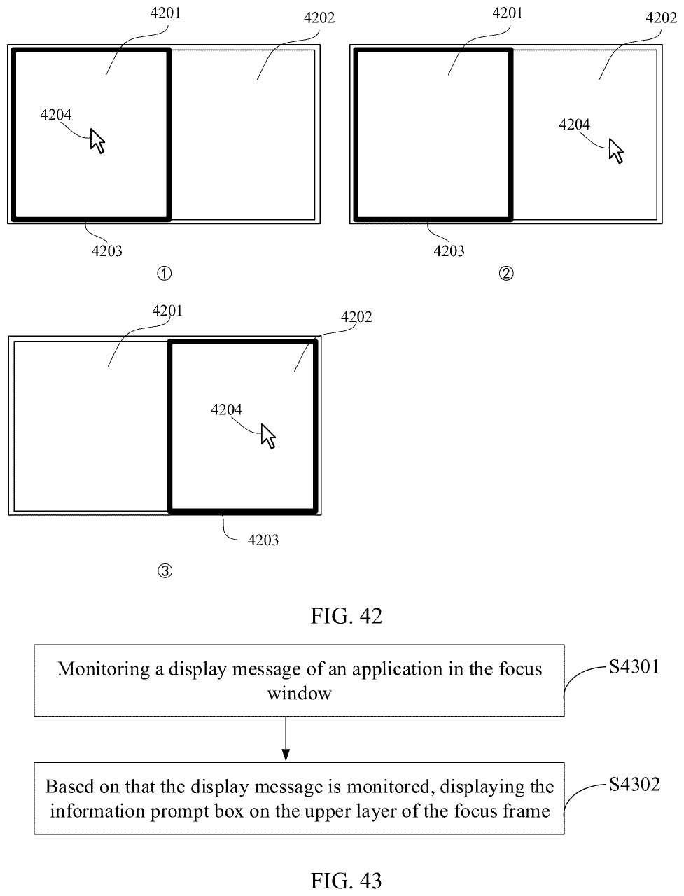

As shown in \textcircled{1} in FIG. 42, the display apparatus 200 displays a first window 4201 and a second window 4202 in a split screen. An image of the first application is displayed in the first window 4201, and an image of the second application is displayed in the second window 4202. A focus window is the first window 4201, and a focus 4204 is displayed in the first window 4201. A focus frame 4203 is displayed on an upper layer of the first window 4201. A user can input a switching command through a mouse to indicate to move the focus into the second window 4202. In response to the switching command, the display apparatus 200 displays the focus 4204 in the second window 4202, as shown in \textcircled{2} in FIG. 42, and modifies the first application stack in the application stack list into an application stack corresponding to the second application, to indicate that the application actually occupying the focus is the second application.

S4102: Detecting, according to a preset period, whether the first application stack in the application stack list and the focus window where the focus frame is located correspond to the same application.

After displaying the first window 4201 and the second window 4202 in a split screen, the display apparatus 200 starts the flow of detecting the application stack at regular intervals. Based on the flow of detecting the application stack at regular intervals shown in FIG. 40, whether the focus frame needs to be updated and displayed is detected according to a preset period. The detection process can refer to the description of the flow shown in FIG. 40 above, and is not described here again.

S4103: Based on that the first application stack in the application stack list and the focus window where the focus frame is located correspond to different applications, displaying the focus frame on a window where an application corresponding to the first application stack is located.

Based on the detection flow, the display apparatus 200 can detect that the first application stack (i.e., the second application) and the application (i.e., the first application) in the first window 4201 where the focus frame 4204 is currently located are not the same application, to determine that the focus frame 4204 needs to be updated and displayed, i.e., as shown in \textcircled{3} in FIG. 42, the focus frame 4203 is displayed on the second window 4202.

When the focus is moved to the window on the other side, after determining layout parameters of the focus frame updated, the layout parameters of the focus frame can be updated by invoking an updateViewLayout method of the WindowManager, such as WindowManager. Update ViewLayout (FocusWindow, MLayoutParams), to update and display the focus frame based on the layout parameters updated.

When an information prompt box appears in the application in the focus window, the display apparatus 200 can display the information prompt box according to the flow shown in FIG. 43, and specific steps are as follows.

S4301: Monitoring a display message of an application in the focus window.

The display message of the application is used for indicating to display an information prompt box. The information prompt box can be a system pop-up window, such as toast.

S4302: Based on that the display message is monitored, displaying the information prompt box on the upper layer of the focus frame.

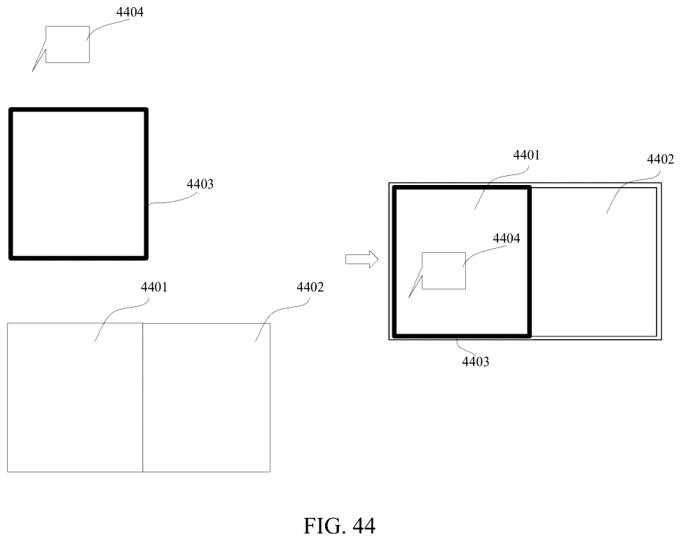

When the display apparatus 200 monitors the display message, the display apparatus 200 displays the information prompt box as shown in FIG. 44. As shown in FIG. 44, a display level gradually increases from bottom to top. The display apparatus 200 displays the first window 4401 and the second window 4402 in a lower display level in a split screen. An image of the first application is displayed in the first window 4401, and an image of the second application is displayed in the second window 4402. A focus frame 4403 is displayed at a higher display level, and a position and size of the focus frame 4403 match a position and size of the first window 4401. When the display apparatus 200 monitors that the first application displays a pop-up window 4404, the pop-up window 4404 is displayed at the highest display level. In this way, the pop-up window 4404 displayed is not blocked and affected by the focus frame 4403.

A computer readable non-transitory storage medium according to embodiments of the present disclosure stores a computer program thereon. The computer program, when executed by a processor, implements respective procedures performed by any one of the processing methods for a display apparatus, and can achieve the same technical effect, so the description is omitted here to avoid repetition.

The computer readable non-transitory storage medium can be, for example, a Read-Only Memory (ROM), a Random Access Memory (RAM), a magnetic disk or an optical disk, etc.

A compute program product according to embodiments of the present disclosure includes a computer program. When the computer program is run on a computer, the computer implements any one of processing methods for a display apparatus.

The foregoing description has been made with reference to specific embodiments for ease of explanation. The above discussion of some embodiment, however, is not intended to be exhaustive or to limit embodiments to the specific forms disclosed in the present disclosure. Many modifications and variations are possible in light of the above teachings. Embodiments are chosen and described in order to best explain principles and practical applications, to enable one of ordinary skilled in the art to better utilize embodiments and various variations of embodiments suitable for specific usage considerations.

What is claimed is:

1. A display apparatus, comprising:
a display, configured to display an image and/or a user interface;
a user input interface, configured to receive a command from a user;
a communicating device, configured to communicate with an external device according to a predetermined protocol;
a memory, configured to store computer instructions and data associated with the display apparatus; and
at least one processor, in connection with the display, the user input interface, the communicating device and the memory, and configured to execute computer instructions to cause the display apparatus to perform:
based on detecting that a target video is being played by a video playing application on the display apparatus, displaying a user prompt interface, wherein the user prompt interface is used for prompting a user whether to enter a split screen working mode;
based on that a command for entering the split screen working mode input from a user on the user prompt interface is received, splitting a display interface of the display apparatus into a first split screen and a second split screen, and starting a search application; and
displaying an interface of the video playing application on the first split screen, and displaying an interface of the search application in full screen on the second split screen.

2. The display apparatus according to claim 1, wherein the at least one processor is further configured to execute computer instructions to cause the display apparatus to perform:
obtaining a size of a preset display interface of the video playing application and a size of a first display interface of the first split screen, wherein the preset display interface is an interface for displaying the target video;
determining a size of a target display interface for displaying the video playing application on the first split screen based on the size of the preset display interface and the size of the first display interface; and
displaying an interface of the video playing application on the first split screen based on the size of the target display interface.

3. The display apparatus according to claim 2, wherein the at least one processor is further configured to execute computer instructions to cause the display apparatus to perform:
determining a target ratio according to the size of the preset display interface; and
determining the size of the target display interface for displaying the video playing application on the first split screen according to the size of the first display interface and the target ratio.

4. The display apparatus according to claim 1, wherein the at least one processor is further configured to execute computer instructions to cause the display apparatus to perform:
determining a size of a second display interface of the second split screen; and
displaying the interface of the search application in full screen on the second split screen based on the size of the second display interface.

5. The display apparatus according to claim 1, wherein the at least one processor is further configured to execute computer instructions to cause the display apparatus to perform:
in response to a search command input from a user, displaying a keyword menu; and
based on that a selection command for a keyword input from a user in the keyword menu is received, invoking the search application, and obtaining media resource information of the target video.

6. The display apparatus according to claim 5, wherein the at least one processor is further configured to execute computer instructions to cause the display apparatus to perform:
in response to the search command input from the user, obtaining attribute information of the target video; and
generating the keyword menu based on the attribute information.

7. The display apparatus according to claim 1, wherein the at least one processor is further configured to execute computer instructions to cause the display apparatus to perform:
based on that a command for starting a preset application input from a user is received, exiting the split screen working mode, and displaying the preset application on the display interface.

8. The display apparatus according to claim 1, further comprising:
a front camera, configured to photograph an environment at a display side of the display and generate a local video, in a started state;
wherein the at least one processor is further configured to execute computer instructions to cause the display apparatus to perform:
based on that a menu pop-up command is received, determining whether a current video played by the display is a fitness teaching video and whether the current video is played by the display in a full screen mode;
based on that the current video is the fitness teaching video and the current video is played by the display in the full screen mode, controlling the display to display a first pop-up menu comprising a split screen display option;
based on that a control command triggering the split screen display option is received, controlling the front camera to start, and receiving the local video generated by the front camera;
controlling the display to split a screen into two display windows and respectively play the current video and the local video in the two display windows.

9. The display apparatus according to claim 8, wherein after the at least one processor controls the display to respectively play the current video and the local video in the two display windows, the at least one processor is further configured to execute computer instructions to cause the display apparatus to perform:
based on that the menu pop-up command is received again, controlling the display to display a second pop-up menu comprising a mirroring option in a first display window for playing the local video;
based on that a control command triggering the mirroring option is received, horizontally mirror flipping the local video, and controlling the display to play the local video horizontally mirror flipped in the first display window.

10. The display apparatus according to claim 9, wherein when the at least one processor controls the display to split the screen into two display windows, the at least one processor is further configured to execute computer instructions to cause the display apparatus to perform:
controlling the display to split the screen into the two display windows on left and right equally;
wherein when the at least one processor controls the display to display the second pop-up menu comprising the mirroring option in the first display window for playing the local video, the at least one processor is configured to execute computer instructions to cause the display apparatus to perform:
obtaining a window width of the display, a preset edge margin width, an option margin width, a quantity of options in the second pop-up menu and widths of the options in the second pop-up menu;
determining a horizontal coordinate of a reference point of the second pop-up menu based on the window width, the edge margin width, the option margin width, the quantity of options in the second pop-up menu, and the widths of the options in the second pop-up menu, wherein the horizontal coordinate of the reference point is a coordinate in a global coordinate system of the display;
controlling the display to display the second pop-up menu comprising the mirroring option at the horizontal coordinate of the reference point, to realize display of the second pop-up menu in the first display window.

11. The display apparatus according to claim 9, wherein when the at least one processor controls the display to display the second pop-up menu comprising the mirroring option in the first display window for playing the local video, a focus window switching option is further displayed in the second pop-up menu simultaneously;
the at least one processor is further configured to execute computer instructions to cause the display apparatus to perform:
based on that a control command triggering the focus window switching option is received, controlling the display to switch a second display window for playing the current video to a focus window, and controlling the display to display a third pop-up menu comprising a full screen play option in the second display window.

12. The display apparatus according to claim 11, wherein after controlling the display to display the third pop-up menu comprising the full screen play option in the second display window, the at least one processor is further configured to execute computer instructions to cause the display apparatus to perform:
based on that a control command triggering the full screen play option is received, controlling the display to resume playing the current video in the full screen mode.

13. The display apparatus according to claim 9, further comprising a speaker;
wherein when the at least one processor controls the display to display the second pop-up menu comprising the mirroring option in the first display window for playing the local video, a full screen play option is further displayed in the second pop-up menu simultaneously;
the at least one processor is further configured to execute computer instructions to cause the display apparatus to perform:
based on that a control command triggering the full screen play option is received, controlling the display to play the local video in the full screen mode, and controlling the speaker to play an audio corresponding to the current video simultaneously.

14. The display apparatus according to claim 8, wherein after the at least one processor controls the display to respectively play the current video and the local video in the two display windows, the at least one processor is further configured to execute computer instructions to cause the display apparatus to perform:
based on that the menu pop-up command is received again, controlling the display to display a third pop-up menu comprising a full screen play option and a focus window switching option in a second display window for playing the current video;
based on that a control command triggering the full screen play option is received, controlling the display to resume playing the current video in the full screen mode;
based on that a control command triggering the focus window switching option is received, controlling the display to switch a first display window for playing the local video to a focus window, and controlling the display to display a second pop-up menu comprising a mirroring option and an exit full screen play option in the first display window.

15. The display apparatus according to claim 8, wherein when the at least one processor controls the display to respectively play the current video and the local video in the two display windows, the at least one processor is further configured to execute computer instructions to cause the display apparatus to perform:
respectively cropping the current video and the local video respectively for fitness image regions according to sizes of the two display windows, to obtain the current video cropped and the local video cropped;
respectively playing the current video cropped and the local video cropped in the two display windows in a full window playing mode.

16. The display apparatus according to claim 1, wherein the at least one processor is further configured to execute computer instructions to cause the display apparatus to perform:
in response to a first selection input for a first application and a second application received through the user input interface, controlling the display to display a selection result for the first application and a selection result for the second application, and present a window arrangement selection control and a split screen control, wherein the first application and the second application support split screen display;
in response to a second selection input for the window arrangement selection control received through the user input interface, determining an arrangement mode of a first split screen region and a second split screen region;
in response to a first control input for the split screen control received through the user input interface, controlling the display to display an interface of the first application in the first split screen region and display an interface of the second application in the second split screen region.

17. The display apparatus according to claim 16, wherein the at least one processor is further configured to execute computer instructions to cause the display apparatus to perform:
controlling the display to display an application selection interface, a first focus frame and/or a second focus frame, wherein the application selection interface is used for displaying an application identifier of one or more applications supporting split screen, the first focus frame is used for indicating an application identifier of a first application pre-selected by a current user, and the second focus frame is used for indicating an application identifier of a second application pre-selected by the current user.

18. The display apparatus according to claim 17, wherein the at least one processor is further configured to execute computer instructions to cause the display apparatus to perform:
in response to the first selection input for the first application and the second application received through the user input interface, moving the first focus frame to a position where the application identifier of the first application is located, and moving the second focus frame to a position where the application identifier of the second application is located;
changing a color of the first focus frame and/or a color of the second focus frame, wherein the first focus frame with the changed color is used for indicating the selection result for the first application for the user, and the second focus frame with the changed color is used for indicating the selection result for the second application for the user.

19. The display apparatus according to claim 16, wherein the at least one processor is further configured to execute computer instructions to cause the display apparatus to perform:
based on the first selection input for the first application and the second application received through the user input interface, controlling the display to present a selection order of the first application and the second application.

20. The display apparatus according to claim 16, wherein the window arrangement selection control at least comprises a left-right arrangement control and a top-bottom arrangement control;
the at least one processor is further configured to execute computer instructions to cause the display apparatus to perform:
in response to a second selection input for the left-right arrangement control received through the user input interface, determining that the first split screen region and the second split screen region are arranged in a left-right split screen mode; or,
in response to a second selection input for the top-bottom arrangement control received through the user input interface, determining that the first split screen region and the second split screen region are arranged in a top-bottom split screen mode.
